(19) United States
(12) Patent Application Publication
(10) Pub. No.: US 2024/0175986 A1
(43) Pub. Date: May 30, 2024

(54) OPTICAL SYSTEM AND LIDAR

(71) Applicant: SUTENG INNOVATION TECHNOLOGY CO., LTD., Shenzhen (CN)

(72) Inventors: Jiachao ZHANG, Shenzhen (CN); Hongju LI, Shenzhen (CN)

(73) Assignee: SUTENG INNOVATION TECHNOLOGY CO., LTD., Shenzhen (CN)

(21) Appl. No.: 18/518,929

(22) Filed: Nov. 24, 2023

(30) Foreign Application Priority Data
Nov. 25, 2022 (CN) 202211496066.5

(51) Int. Cl. G01S 7/481

(52) U.S. Cl. CPC G01S 7/4813; G01S 7/4815

(57) ABSTRACT

This application discloses an optical system and a LiDAR, where the optical system includes a bracket and at least one first optical assembly; the bracket includes a first end surface and a second end surface that are arranged back to back, where the bracket is also provided with a first accommodation cavity, and the first accommodation cavity extends along a first axial direction and communicates with the first end surface and the second end surface; and the first optical assembly includes at least one optical element, and the optical element included in the first optical assembly is arranged in the first accommodation cavity along the first axial direction, and abuts against an inner wall of the first accommodation cavity.

### CROSS-REFERENCE TO RELATED APPLICATION

The present application claims the benefit of priority to Chinese Patent Application No. 202211496066.5, filed on Nov. 25, 2022, which is hereby incorporated by reference in its entirety.

### TECHNICAL FIELD

This application pertains to the field of Light Detection and Ranging (LiDAR), and in particular, to an optical system and a LiDAR.

### TECHNICAL BACKGROUND

A LiDAR is a radar system using lasers to detect characteristics of a target object, such as position and speed. A working principle of the LiDAR is that a laser emission module first emits an outgoing laser for detection to the target, and a laser receiving module then receives an echo laser reflected from the target object, and processes the received echo laser, to obtain relevant information of the target object, for example, parameters such as distance, azimuth, height, speed, attitude, and even shape. Optical systems usually need to be configured for the laser emission module and the laser receiving module, to obtain point cloud data with a large angle of view and high resolution.

Currently, an optical element in an optical system of a laser ranging apparatus usually needs to be assembled in a lens barrel first, and then assembled on a bracket through the lens barrel. Therefore, not only complexity of production and assembly is increased, but also more parts are required by the optical system, thereby increasing production costs.

### SUMMARY

Embodiments of this application provide an optical system and a LiDAR, which can simplify production and assembly processes of the optical system and can reduce the number of parts of the optical system, thereby reducing production costs.

According to a first aspect, embodiments of this application provides an optical system, including: a bracket, including a first end surface and a second end surface that are arranged back to back, where the bracket is also provided with a first accommodation cavity, and the first accommodation cavity extends along a first axial direction and communicates with the first end surface and the second end surface; and a first optical assembly, where each first optical assembly includes at least one optical element, and the optical element included in the first optical assembly is arranged in the first accommodation cavity along the first axial direction, and abuts against an inner wall of the first accommodation cavity.

According to a second aspect, embodiments of this application provides LiDAR, including the foregoing optical system, where the LiDAR further includes a housing, a light-emitting module and a detection module, the housing is connected to the second end surface, and after the housing is connected to the second end surface, an accommodation cavity is formed; and the light-emitting module and the detection module are both disposed in the accommodation cavity.

In the optical system provided in embodiments of this application, mounting space is provided for the first optical assembly through the first accommodation cavity of the bracket, and the optical element in the first optical assembly is positioned through the first restrictive assembly, so that the first optical assembly can be directly mounted on the bracket. That is, the bracket reuses a function of a lens barrel. This application can simplify the production and assembly processes of the optical system and reduce the number of parts in the optical system, thereby reducing the production costs.

### BRIEF DESCRIPTION OF DRAWINGS

To explain the technical solution in the embodiments in this application, the following briefly introduces the accompanying drawings required to describe the embodiments or the related art. Obviously, the accompanying drawings in the following description are only some embodiments in this application.

FIG. 1 is a schematic cross-sectional view of an optical system according to an embodiment;

FIG. 2 is a schematic cross-sectional view of a bracket according to an embodiment;

FIG. 3 is an enlarged schematic diagram at Ain FIG. 1;

FIG. 4 is an enlarged diagram at B in FIG. 1;

FIG. 5 is a front view of a bracket according to an embodiment;

FIG. 6 is a three-dimensional diagram of a light-transmitting sheet according to an embodiment;

FIG. 7 is a three-dimensional diagram of a bracket according to an embodiment;

FIG. 8 is an enlarged diagram at C in FIG. 1;

FIG. 9 is an enlarged diagram at D in FIG. 1;

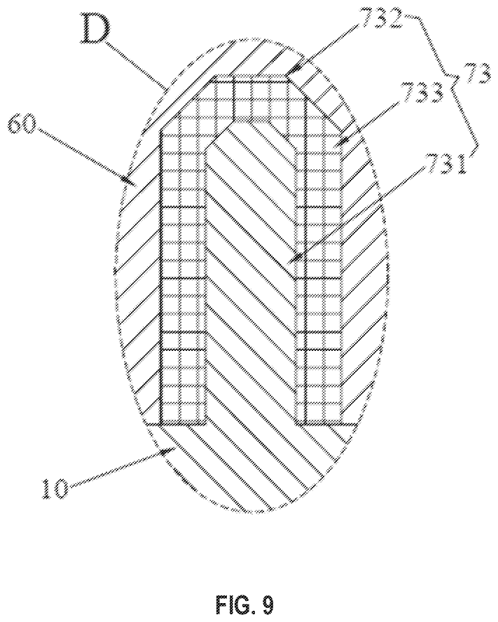

FIG. 10 is an enlarged diagram at E in FIG. 1;

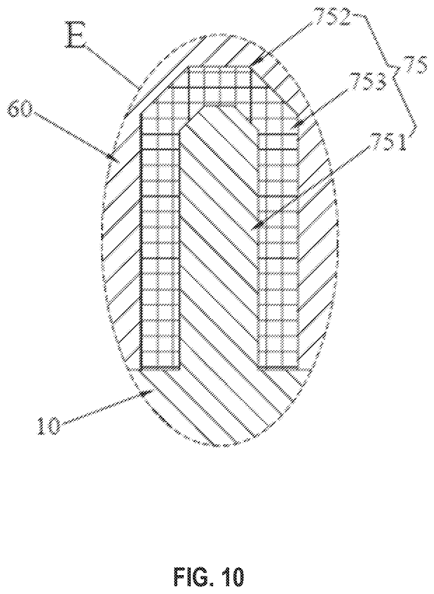

FIG. 11 is a schematic cross-sectional view of a LiDAR according to an embodiment;

FIG. 12 is a schematic cross-sectional view along a direction G-G in FIG. 11; and

FIG. 13 is a schematic cross-sectional view along a direction H-H in FIG. 11.

### DETAILED DESCRIPTION

To make the objectives, technical solutions, and advantages of this application more comprehensible, the following further describes this application in detail with reference to accompanying drawings and embodiments.

When being “fastened to,” “disposed on,” or “provided on” another element, an element can be directly or indirectly located on the another element. When being “connected to” another element, an element can be directly or indirectly connected to the another element.

Azimuth or position relationships indicated by terms such as “axial,” “radial,” “vertical,” “horizontal,” “left” and “right” are based on the azimuth or position relationships shown in the accompanying drawings, are merely relative concepts for each other or are described with reference to a normal use status of the product, and are intended to describe this application and simplify the descriptions, but are not intended to indicate or imply that the specified device or element shall have specific azimuth or be formed and operated in specific azimuth.

In addition, the terms of “first,” “second,” “third,” “fourth,” “fifth,” “sixth,” “seventh” and “eighth” are merely intended for a purpose of description, a feature with a determiner such as “first” or “second” can expressly or implicitly include one or more features.

In the description of this application, “multiple” means “two or more than two”, unless otherwise clearly and specifically defined. “A and/or B” includes three cases: (1) only A is met; (2) only B is met; and (3) both A and B are met. “A or B” includes two cases: (1) only A is met; and (2) only B is met. “A and B” only includes one case: both A and B are met.

This application provides an optical system and a LiDAR, to simplify production and assembly processes of the optical system and reduce the number of parts of the optical system, thereby reducing production costs.

Embodiment 1 is as follows.

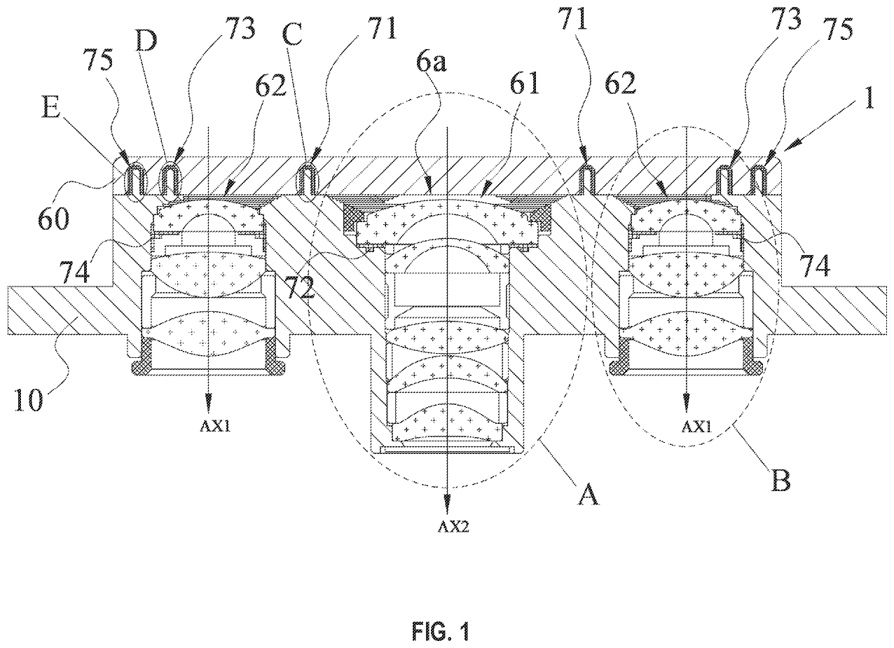

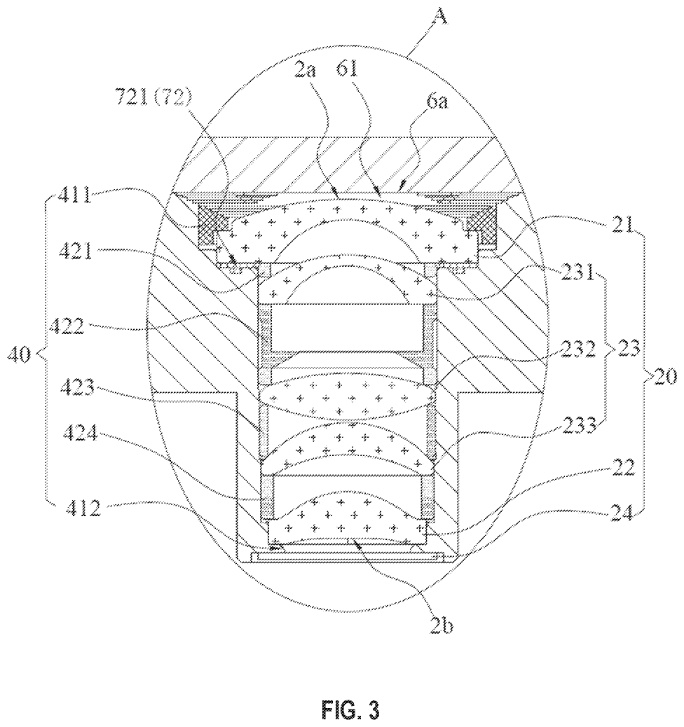

According to a first aspect, as shown in FIG. 1 and FIG. 3, this application provides an optical system 1, including: a bracket 10, a first optical assembly 20, and a first restrictive assembly 40. The bracket 10 includes a first end surface 11 and a second end surface 12 that are arranged back to back, where the bracket 10 is also provided with a first accommodation cavity 13, and the first accommodation cavity 13 extends along a first axial direction AX1 and communicates with the first end surface 11 and the second end surface 12. The first optical assembly 20 includes at least one optical element, and the optical element included in the first optical assembly 20 is arranged in the first accommodation cavity 13 along the first axial direction AX1, and abuts against an inner wall of the first accommodation cavity 13 along the first radial direction, where the first radial direction is a direction perpendicular to the first axial direction AX1. The optical element included in the first optical assembly 20 abuts against the inner wall of the first accommodation cavity 13, which can prevent the optical element included in the first optical assembly 20 from moving in the first accommodation cavity 13 along the first radial direction. The first restrictive assembly 40 is connected to the inner wall of the first accommodation cavity 13 and is configured to restrict the optical element included in the first optical assembly 20, to prevent the optical element included in the first optical assembly 20 from moving in the first accommodation cavity 13 along the first axial direction AX1.

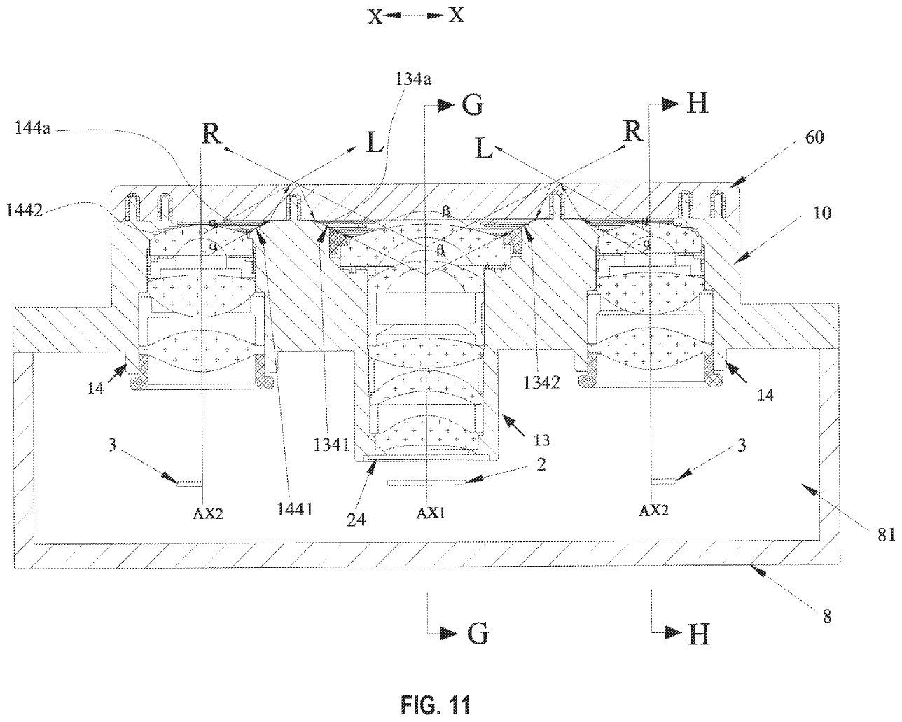

In some embodiments, the bracket 10 is configured to provide mounting space for the optical element included in the first optical assembly 20. The bracket 10 can also be connected to the entire device (for example, the LiDAR) to mount the first optical system 1 into the entire device. In a specific embodiment, the bracket 10 can be connected to a housing 8 of the entire device (as shown in FIG. 11 to FIG. 13), thereby mounting the first optical system 1 into the entire device. The bracket 10 is made of an opaque material to prevent light from passing through the bracket 10 and being emitted to the optical element in the first optical assembly 20. The opaque material is a material that does not allow light to pass through, for example, opaque plastic, metal or resin. This application does not limit the specific manufacturing materials for bracket 10.

In some embodiments, the first optical assembly 20 is a collection of optical elements. The first optical assembly 20 may include one or more optical elements. An optical element is made of a light-transmitting material for allowing transmission of the light ray, and adjusting the light ray, for example, changing a propagation direction of the light ray, changing a light spot form and a light spot size of the light beam consisting of a number of light rays. The light-transmitting material is a material that allows light to pass through, for example, light-transmitting glass, plastic or resin. In an embodiment, the optical elements in the first optical assembly 20 include lenses, and when the optical elements in the first optical assembly 20 include lenses, the lenses may include a convex lens, a concave lens, a spherical mirror, and an aspheric mirror. In the optical system 1 provided in the embodiment, the first accommodation cavity 13 is provided in the bracket 10, to provide mounting space for the first optical assembly 20, and the optical element in the first optical assembly 20 is positioned through the first restrictive assembly 40, so that the first optical assembly 20 can be directly mounted on the bracket 10. That is, the bracket 10 reuses a function of a lens barrel. This solution can simplify the production and assembly processes of the optical system and reduce the number of parts in the optical system, thereby reducing the production costs.

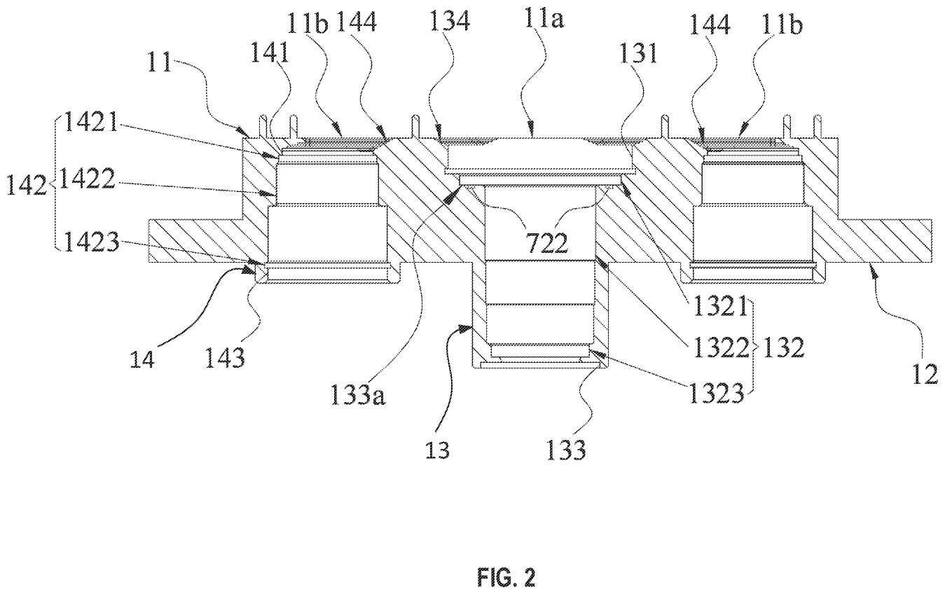

Referring to FIG. 1, FIG. 2, and FIG. 3, in an embodiment, the optical system 1 includes one first optical assembly 20. Correspondingly, the bracket 10 is provided with one first accommodation cavity 13, and the optical system 1 includes one first restrictive assembly 40 corresponding to one first optical assembly 20. In an embodiment, the optical system 1 includes multiple first optical assemblies 20 (hereinafter, “multiple” means “two or more than two”). Correspondingly, the bracket 10 is provided with multiple first accommodation cavities 13 in a one-to-one correspondence with the multiple first optical assemblies 20. The optical system 1 includes multiple first restrictive assemblies 40 in a one-to-one correspondence with the multiple first accommodation cavities 13.

Referring to FIG. 1 and FIG. 3, the first optical assembly 20 includes one or more lenses (for example, the first lens 21, the second lens 22, and the first middle lens group 23 in FIG. 3). The first optical assembly 20 has a first optical surface 2 and a second optical surface 2b, where each lens in the first optical assembly 20 includes two optical surfaces disposed opposite each other along the first axial direction AX1, and light can enter through one of the two optical surfaces disposed opposite each other and exit from the other of the two optical surfaces disposed opposite each other. The first optical surface 2 is an optical surface at the first position when all the lenses included in the first optical assembly 20 are arranged along the first axial direction AX1, and the second optical surface 2b is an optical surface at the last position when all the lenses included in the first optical assembly 20 are arranged along the first axial direction AX1.

In some embodiments, when the first optical assembly 20 includes one lens, the first optical surface 2 and the second optical surface 2b are two optical surfaces disposed opposite each other in the same lens. When the first optical assembly 20 includes multiple lenses, the two optical surfaces disposed opposite each other in each lens along the first axial direction AX1 are respectively denoted as the first optical surface and the second optical surface of the lens. The first optical surface 2 is a first optical surface of a lens at the first position when the multiple lenses are arranged along the first axial direction AX1, and the second optical surface 2b is a second optical surface of a lens at the last position when the multiple lenses are arranged along the first axial direction AX1.

As shown in FIG. 2, the inner wall of the first accommodation cavity 13 is disposed to form a complete circle and includes a first inner wall portion 131, a first middle inner wall portion 133 and a second inner wall portion 132 arranged along the first axial direction AX1. As shown in FIG. 3, the first restrictive assembly 40 includes a first restrictive member 411 and a second restrictive member 412. The first restrictive member 411 is connected to the first inner wall portion 131 of the first accommodation cavity 13. The second restrictive member 412 is connected to the second inner wall portion 132 of the first accommodation cavity 13. The lenses included in the first optical assembly 20 are sequentially arranged in the accommodation space enclosed by the first middle inner wall portion 133 along the first axial direction AX1, the first optical surface 2 of the first optical assembly 20 abuts against the first restrictive member 411. The second optical surface 2b of the first optical assembly 20 abuts against the second restrictive member 412, and the lenses included in the first optical assembly 20 abut against the first middle inner wall portion 133 along the first radial direction. The first restrictive member 411 is configured to restrict the lenses included in the first optical assembly 20, to prevent the lenses included in the first optical assembly 20 from detaching from the first accommodation cavity 13 through the accommodation space defined by the first inner wall portion 131. The second restrictive member 412 is configured to restrict the lenses included in the first optical assembly 20, to prevent the lenses included in the first optical assembly 20 from detaching from the first accommodation cavity 13 through the accommodation space defined by the second inner wall portion 132.

Further, the first restrictive member 411 is disposed around the first inner wall portion 131, and a light-transmitting through hole is also provided in the middle of the first restrictive member 411. The light-transmitting through hole of the first restrictive member 411 is configured to allow light to pass through. The second restrictive member 412 is disposed around the second inner wall portion 132, and a light-transmitting through hole is also provided in the middle of the second restrictive member 412. The light-transmitting through hole of the second restrictive member 412 is configured to allow light to pass through.

Further, when the first optical assembly 20 includes multiple lenses, the first restrictive assembly 40 further includes a spacer. One spacer is disposed between each two adjacent lenses in the multiple lenses included in the first optical assembly 20. Two ends of the spacer disposed between the two adjacent lenses along the first axial direction AX1 respectively abut against the two corresponding lenses, and are configured to space the two adjacent lenses apart. An outer side wall of the spacer disposed between the two adjacent lenses abuts against the first middle inner wall portion 133 along the first radial direction, so that the spacer can be prevented from moving along the first radial direction. For example, the first optical assembly 20 includes M lenses disposed along the first axial direction AX1, where M is a positive integer greater than or equal to 2. The first restrictive assembly 40 further includes M−1 spacers, an (m−1)^{th} spacer is disposed between an (m−1)^{th} lens and an m^{th} lens, where m is a positive integer, and 2≤m≤M. Two ends of the (m−1)^{th} spacer along the first axial direction AX1 respectively abut against a second optical surface of the (m−1)^{th} lens and a first optical surface of the m^{th} lens, and are configured to space the (m−1)^{th} lens and the m^{th} lens apart. An outer side wall of the (m−1)^{th} spacer abuts against the first middle inner wall portion 133 of the first accommodation cavity 13 along the first radial direction, to prevent the (m−1)^{th} spacer from moving along the first radial direction. The (m−1)^{th} spacer is also provided with a light-transmitting through hole to allow light between the (m−1)^{th} lens and the m^{th} lens to pass through.

In an embodiment, a principle of restricting the lenses included in the first optical assembly 20 by the first restrictive assembly 40 is as follows. The lenses included in the first optical assembly 20 and the spacers included in the first restrictive assembly 40 abut against the first middle inner wall portion 133 of the first accommodation cavity 13 along the first radial direction. Therefore, the lenses included in the first optical assembly 20 and the spacers included in the first restrictive assembly 40 cannot move in the first accommodation cavity 13 in the first radial direction, but can move only along the first axial direction AX1. The first restrictive member 411 and the second restrictive member 412 restrict the first optical surface 21a and the second optical surface 22b of the first optical assembly 20 to confine the lenses included in the first optical assembly 20 to the first accommodation cavity 13. The spacer disposed between each two adjacent lenses can provide support for the two adjacent lenses, so that each lens is disposed at preset intervals, thereby fixing the lenses included in the first optical assembly 20 into the first accommodation cavity 13.

As shown in FIG. 3, in an embodiment, the first optical assembly 20 includes a first lens 21, a first middle lens group 23, and a second lens 22 arranged sequentially along the first axial direction AX1, where the first middle lens group 23 includes a first middle lens 231, a second middle lens 232, and a third middle lens 233 arranged sequentially along the first axial direction AX1. The first restrictive member 411 is connected to the first inner wall portion 131 and abuts against the first optical surface (for example, the first optical surface 2 shown in FIG. 3) included in the first lens 21, to prevent five lenses included in the first optical assembly 20 from detaching from the first accommodation cavity 13 through the accommodation space defined by the first inner wall portion 131. The second restrictive member 412 is connected to the second inner wall portion 132 and abuts against the second optical surface (for example, the second optical surface 2b shown in FIG. 3) of the second lens 22, to prevent the five lenses included in the first optical assembly 20 from detaching from the first accommodation cavity 13 through the accommodation space defined by the second inner wall portion 132.

Still referring to FIG. 3, the spacer included in the first restrictive assembly 40 further includes a first spacer 421, a second spacer 422, a third spacer 423, and a fourth spacer 424. The first spacer 421 is disposed between the second optical surface of the first lens 21 and the first optical surface of the first middle lens 231, and is configured to provide support for the first lens 21 and the first middle lens 231, thereby spacing the first lens 21 and the first middle lens 231 apart. The second spacer 422 is disposed between the second optical surface of the first middle lens 231 and the first optical surface of the second middle lens 232, and is configured to provide support for the first middle lens 231 and the second middle lens 232, thereby spacing the first middle lens 231 and the second middle lens 232 apart. The third spacer 423 is disposed between the second optical surface of the second middle lens 232 and the first optical surface of the third middle lens 233, and is configured to provide support for the second middle lens 232 and the third middle lens 233, thereby spacing the second middle lens 232 and the third middle lens 233 apart. The fourth spacer 424 is disposed between the second optical surface of the third middle lens 233 and the first optical surface of the second lens 22, and is configured to provide support for the third middle lens 233 and the second lens 22, thereby spacing the third middle lens 233 and the second lens 22 apart.

Further, a light-transmitting through hole of the first restrictive member 411 is configured to allow light corresponding to the first lens 21 to pass through. A light-transmitting through hole of the first spacer 421 is configured to allow light to be transmitted between the first lens 21 and the first middle lens 231. A light-transmitting through hole of the second spacer 422 is configured to allow light to be transmitted between the first middle lens 231 and the second middle lens 232. A light-transmitting through hole of the third spacer 423 is configured to allow light to be transmitted between the second middle lens 232 and the third middle lens 233. A light-transmitting through hole of the fourth spacer 424 is configured to allow light to be transmitted between the third middle lens 233 and the second lens 22, and a light-transmitting through hole of the second restrictive member 412 is configured to allow light corresponding to the second lens 22 to pass through.

Still referring to FIG. 2, in an embodiment, the first middle inner wall portion 133 includes a first inner wall sub-portion 1331, a first main inner wall portion 1333, and a second inner wall sub-portion 1332 arranged sequentially along the first axial direction AX1. A dimension of the first inner wall sub-portion 1331 along the first radial direction is greater than that of the first main inner wall portion 1333, and a dimension of the first main inner wall portion 1333 along the first radial direction is greater than that of the second inner wall sub-portion 1332. The second restrictive member 412 is integrally formed with the bracket 10, and the first restrictive member 411 and the bracket 10 are two parts that are independently processed. When the lens included in the first optical assembly 20 needs to be mounted into the first accommodation cavity 13, the accommodation space defined by the first inner wall portion 131 is first used as an entrance, to put the lens included in the first optical assembly 20 and the first spacer included in the first restrictive assembly 40 into the first accommodation cavity 13 sequentially. After the lens included in the first optical assembly 20 and the first spacer included in the first restrictive assembly 40 are sequentially put into the first accommodation cavity 13 through the accommodation space defined by the first inner wall portion 131, the first restrictive member 411 is put into the first accommodation cavity 13 and is connected to the first inner wall portion 131.

In an embodiment, external threads are disposed on an outer side wall of the first restrictive member 411 (not shown), and internal threads are disposed on the first inner wall portion 131 (not shown). The first restrictive member 411 and the first inner wall portion 131 are connected through threads. The second restrictive member 412 is an annular bulge formed by recessing the second inner wall portion 132 into the first accommodation cavity 13.

In some embodiments, the first restrictive member 411 is welded to the first inner wall portion 131. In some embodiments, the first restrictive member 411 can be connected to the first inner wall portion 131 through ultrasonic welding or laser welding.

In some embodiments, the second restrictive member 412 may also be a part processed independently of the bracket 10. In some embodiments, external threads are disposed on an outer side wall of the second restrictive member 412, and internal threads are disposed on the second inner wall portion 132. The second restrictive member 412 and the second inner wall portion 132 are connected through threads. In some embodiments, the second restrictive member 412 may be welded to the second inner wall portion 132. In some embodiments, the second restrictive member 412 can be connected to the second inner wall portion 132 through ultrasonic welding or laser welding. At this time, when the lens included in the first optical assembly 20 needs to be mounted into the first accommodation cavity 13, the second restrictive member 412 can be first put into the first accommodation cavity 13 and connected to the second inner wall portion 132, then the accommodation space defined by the first inner wall portion 131 is used as an entrance, to put the lens included in the first optical assembly 20 and the spacer included in the first restrictive assembly 40 into the first accommodation cavity 13 sequentially. After the lens included in the first optical assembly 20 and the spacer included in the first restrictive assembly 40 are sequentially put into the first accommodation cavity 13 through the accommodation space defined by the first inner wall portion 131, the first restrictive member 411 is put into the first accommodation cavity 13 and is connected to the first inner wall portion 131 through, for example, threaded or welded connection.

Referring to FIG. 1 and FIG. 2, the optical system 1 also includes a light-transmitting sheet 60. The light-transmitting sheet 60 is connected to the first end surface 11 of the bracket 10 and includes a first light-transmitting surface 6a facing toward the first end surface 11. The light-transmitting sheet 60 is configured to provide protection for the first optical assembly 20 mounted on the bracket 10 and is also configured to allow light corresponding to the first optical assembly 20 to pass through. When the first optical assembly 20 is configured to emit light, the light emitted by the first optical assembly 20 can be emitted outward through the light-transmitting sheet 60; and when the first optical assembly 20 is configured to receive light, external light can pass through the light-transmitting sheet 60 to enter the first optical assembly 20.

In some embodiments, the light-transmitting sheet 60 is made of a light-transmitting material. The light-transmitting material refers to a material that allows light to pass through, including light-transmitting glass, light-transmitting plastic, light-transmitting resin or the like. The light-transmitting sheet 60 can be circular or square or in other shapes. This application does not limit the shape or thickness of the light-transmitting sheet 60 and they can be selected based on actual needs.

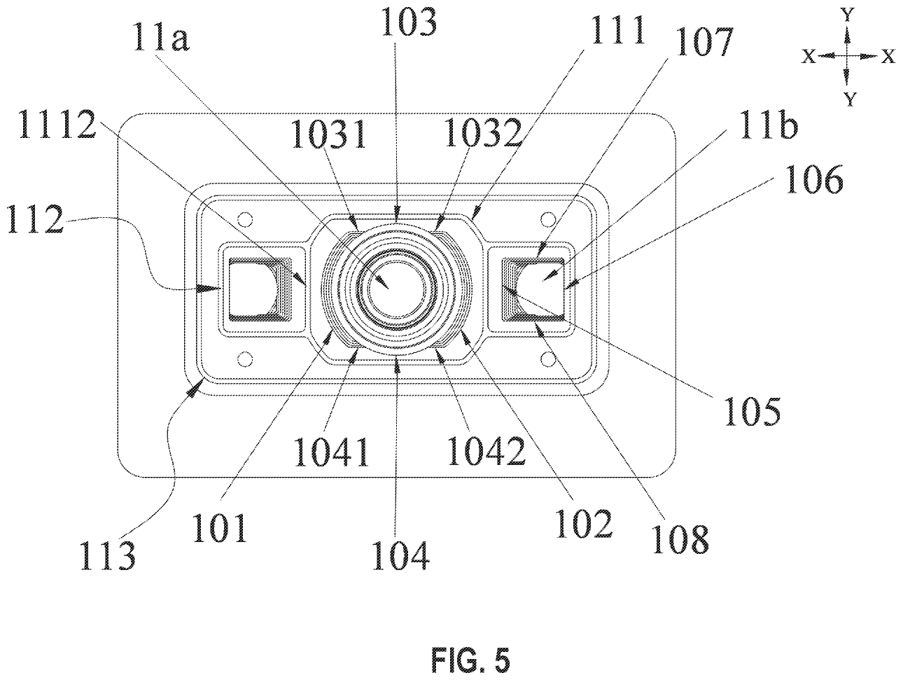

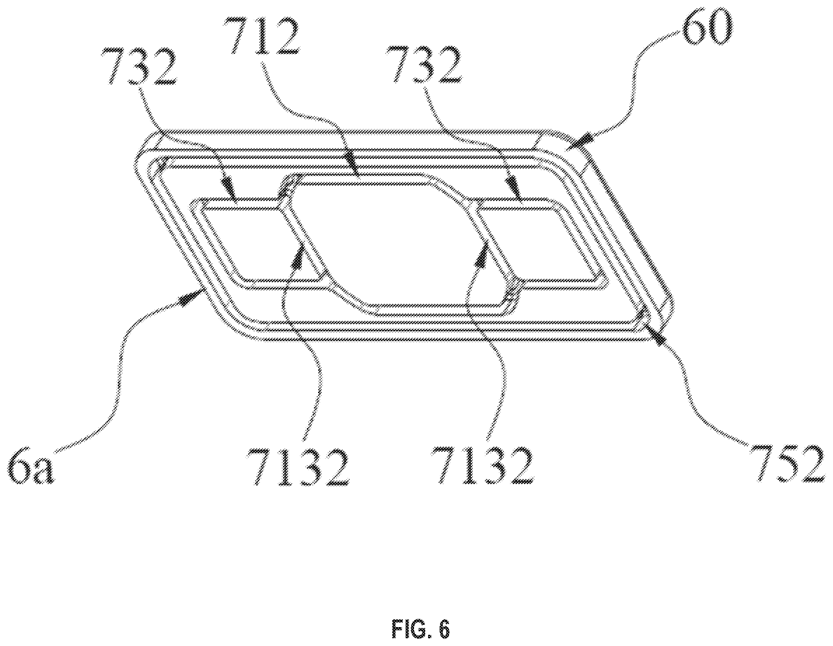

Referring to FIG. 1, FIG. 2, and FIG. 5, the first end surface 11 of the bracket 10 is provided with a first through hole 11a that communicates with the first accommodation cavity 13. The first end surface 11 of the bracket 10 has a first sealing path 111, and the first sealing path 111 is disposed around a circumferential side of the first through hole 11a. Referring to FIG. 1 and FIG. 5 to FIG. 6, the optical system 1 further includes a first sealed connection structure 71 and a second sealed connection structure 72. The first sealed connection structure 71 is configured to form a sealed connection between the first sealing path 111 and the first light-transmitting surface 6a, and the second sealed connection structure 72 is configured to form a sealed connection between the first optical element (for example, the first lens 21 in FIG. 3 and FIG. 6) and the inner wall of the first accommodation cavity 13. The first optical element is an optical element (for example, the first lens 21 in FIG. 3 and FIG. 6) at the first position when optical elements included in the first optical assembly 20 are arranged along the first axial direction AX1. The first sealed connection structure 71 and the second sealed connection structure 72 can form a sealed first compartment 61 between the light-transmitting sheet 60 and the first optical element of the first optical assembly 20.

In the optical system 1 disclosed in some embodiments, a sealed first compartment 61 is formed between the light-transmitting sheet 60 and the first optical element, which can reduce an amount of water vapor in contact with the first light-transmitting surface 6a of the light-transmitting sheet 60, so that a condensation (water droplets formed by pre-cooling and condensation of water vapor) phenomenon caused because water vapor condenses on the first light-transmitting surface 6a of the light-transmitting sheet 60 can be effectively alleviated. In addition, when the optical system 1 is applied to the LiDAR, the bracket 10 is mounted on the housing 8 of the LiDAR. An accommodation cavity 81 is formed between the second end surface 12 of the bracket 10 and the housing 8. A circuit system of the LiDAR is disposed in the accommodation cavity 81, and during working of the circuit system, a large amount of heat is generated, thereby causing higher water vapor temperature in the accommodation cavity 81 when the LiDAR is working. If no independent first compartment 61 is formed between the light-transmitting sheet 60 and the first optical element, the hot water vapor can come into contact with the first light-transmitting surface 6a of the light-transmitting sheet 60 through the first accommodation cavity 13, and the light-transmitting sheet 60 is close to external air and is at lower temperature, and when the hot water vapor comes into contact with the first light-transmitting surface 6a of the light-transmitting sheet 60, the condensation phenomenon is more likely to appear. In the related art, there is no independent sealed first compartment 61 formed between the light-transmitting sheet 60 and the first optical element, resulting in a large amount of water vapor on the side near the first optical element coming in contact with the first light-transmitting surface 6a of the light-transmitting sheet 60. Water vapor is prone to form condensation on the first transparent surface 6a of the transparent sheet 60. When light passes through the condensation, it will refract and deviate from the original optical path, which further affects the detection effect when using light (such as laser) for detection.

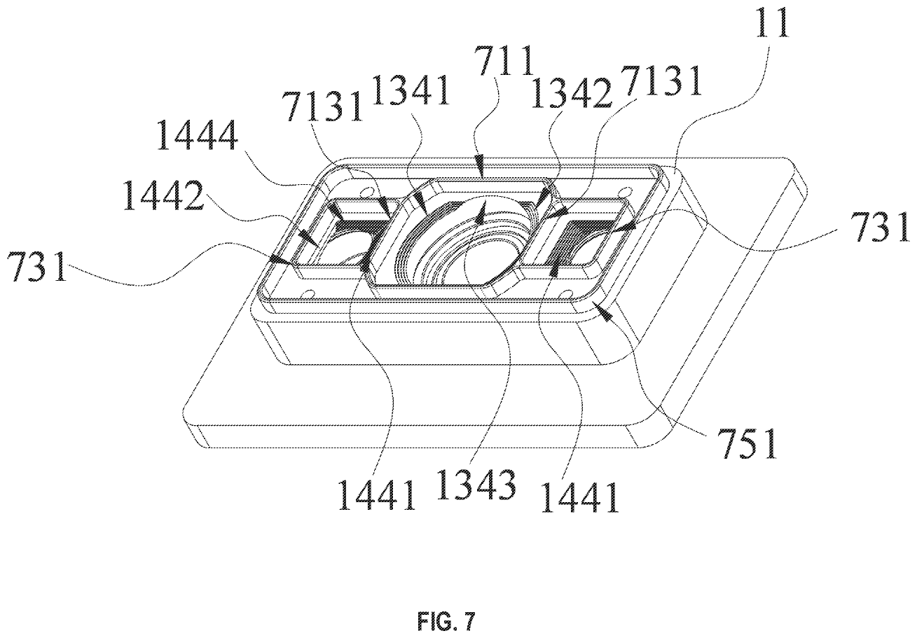

Referring to FIG. 5 to FIG. 7, in some embodiments, the first sealed connection structure 71 includes a first sealing bulge 711, a first sealing groove 712, and a first sealing rubber ring 713. The first sealing bulge 711 is disposed on the first end surface 11 along the first sealing path 111. The first sealing groove 712 is disposed on the first light-transmitting surface 6a of the light-transmitting sheet 60 and corresponds to the first sealing bulge 711. The first sealing rubber ring 713 is filled inside the first sealing groove 712. The first sealing bulge 711 is embedded in the first sealing groove 712, and is seal-connected to the first sealing groove 712 through the first sealing rubber ring 713, thereby implementing sealed connection between the first sealing path 111 of the first end surface 11 and the first light-transmitting surface 6a of the light-transmitting sheet 60.

Referring to FIG. 5, in an embodiment, the first sealing bulge 711 is integrally formed with the bracket 10, which can better ensure a sealing effect, and facilitates processing. In some embodiments, the first sealing bulge 711 and the bracket 10 are two parts that are independently formed, and the first sealing bulge 711 can be connected to the first sealing path 111 on the bracket 10 through welding or glue binding, thereby ensuring the sealing effect.

Further, the first sealing bulge 711 is made of an opaque material. In an embodiment, the bracket 10 is made of an opaque material, and correspondingly, the first sealing bulge 711 integrally formed with the bracket 10 is also made of an opaque material. The first sealing bulge 711 is made of the opaque material, which can improve light blocking performance of the first compartment 61 and reduce a probability of entering the first optical assembly 20 by stray light. The stray light includes light outside a preset optical path range of the first optical assembly 20. In some embodiments, the stray light may include light formed by light outside the preset optical path range of the first optical assembly 20 that enters the first optical assembly 20 located in the first accommodation cavity 13 after being reflected by the light-transmitting sheet 60. The preset optical path range of the first optical assembly 20 refers to a range that is preset by a technician when designing the optical path of the first optical assembly 20 and that can be covered by incident light and outgoing light of the first optical assembly 20.

In some embodiments, the first sealing groove 712 is disposed on the first end surface 11 along the first sealing path 111. The first sealing bulge 711 is disposed on the first light-transmitting surface 6a and corresponds to the first sealing groove 712. The first sealing rubber ring 713 is filled inside the first sealing groove 712. The first sealing bulge 711 is embedded in the first sealing groove 712, and is seal-connected to the first sealing groove 712 through the first sealing rubber ring 713, thereby implementing sealed connection between the first sealing path 111 of the first end surface 11 and the first light-transmitting surface 6a of the light-transmitting sheet 60. Further, the first sealing bulge 711 may be integrally formed with the light-transmitting sheet 60.

In some embodiments, the first sealed connection structure includes a first welded connection structure, and the first welded connection structure is a welded structure formed after the first end surface 11 and the first light-transmitting surface 6a are welded along the first sealing path 111.

In an embodiment, the bracket 10 and the light-transmitting sheet 60 are made of PC (polycarbonate) plastic, and the first welded connection structure can be a welded structure formed by welding the first end surface 11 and the first light-transmitting surface 6a along the first sealing path 111 through ultrasonic welding, thereby forming the sealed connection between the first sealing path 111 and the first lens surface 61. The bracket 10 can also be made of other types of opaque plastic materials, and the light-transmitting sheet 60 can also be made of other types of plastic materials that can transmit light, provided that the bracket 10 and the light-transmitting sheet 60 can be connected through ultrasonic welding. This application does not limit the material of the bracket 10 and the light-transmitting sheet 60.

In an embodiment, the light-transmitting sheet 60 is made of the light-transmitting material, and the bracket 10 is made of the opaque material. The first welded connection structure can be a welded structure formed by welding the first end surface 11 and the first light-transmitting surface 6a along the first sealing path 111 through laser welding, thereby forming the sealed connection between the first sealing path 111 and the first lens surface 61. At this time, it is only required that the bracket 10 and the light-transmitting sheet 60 can be connected through laser welding. This application does not limit the material of the bracket 10 and the light-transmitting sheet 60.

As shown in FIG. 2, a first connection inner wall 133a is also disposed between the first inner wall sub-portion 1331 and the first main inner wall portion 1333. In some embodiments, the first connection inner wall 133a is formed by extending an end of the first main inner wall portion 1333 that is closer to the first inner wall portion 131 outward in a radial direction. The first inner wall sub-portion 1331 is formed by extending a side of the first connection inner wall 133a that is closer to the first inner wall portion 131 along the axial direction. The first inner wall sub-portion 1331 and the first inner wall portion 131 are connected. Referring to FIG. 1 and FIG. 2, the second sealed connection structure 72 is disposed between the first connection inner wall 133a and the second optical surface of the first optical element (the first lens 21 in FIG. 3) and is configured to be connected to the first connection inner wall 133a and the second optical surface of the first optical element (the first lens 21 in FIG. 3), thereby implementing sealed connection between the first optical element and the inner wall of the first accommodation cavity 13.

In an embodiment, the second sealed connection structure 72 includes a second sealing rubber ring 721 disposed into a complete circle, and the second sealing rubber ring is filled between the first connection inner wall 133a and the second optical surface of the first optical element, to bind the first connection inner wall 133a with the first optical element (the first lens 21 in FIG. 3) of the first optical assembly 20, thereby implementing sealed connection between the first optical element (the first lens 21 in FIG. 3) of the first optical assembly 20 and the inner wall of the first accommodation cavity 13.

Referring to FIG. 2, a second sealing groove 722 is also disposed on the first connection inner wall 133a, and the second sealing groove 722 is disposed into a complete circle. After the second sealing rubber ring 721 is filled into the second sealing groove 722, the first optical element (the first lens 21 in FIG. 3) of the first optical assembly 20 is bound with the first connection inner wall 133a of the first accommodation cavity 13.

Referring to FIG. 2, the inner wall of the first accommodation cavity 13 further includes a first light blocking inner wall 134. The first light blocking inner wall 134 is located between the first through hole 11a and the side of the first optical assembly 20 that is closer to the first through hole 11a. Space defined by the first light blocking inner wall 134 is configured to allow light within the preset optical path range to enter or exit the first optical assembly 20.

Further, at least part of a wall surface of the first light blocking inner wall 134 is provided with multiple first light blocking grooves 134 arranged in sequence. Large-angle stray light that is at an angle outside the preset receiving optical path range of the first optical assembly 20 and that is emitted toward the first light blocking inner wall 134 can be reflected by the first light blocking groove 134, which can effectively dissipate energy of the large-angle stray light, thereby further reducing impact of the large-angle stray light on the optical system 1.

In some embodiments, the first light blocking inner wall 134 is disposed between the first through hole 11a and the first inner wall portion 131, and the multiple first light blocking grooves 134 arranged in sequence are step-shaped.

Referring to FIG. 1, the optical system 1 further includes a second optical assembly 30 and a second restrictive assembly 50. The bracket 10 is provided with a second accommodation cavity 14, and the second accommodation cavity 14 extends along a second axial direction AX2 and communicates with the first end surface 11 and the second end surface 12. The second optical assembly 30 includes at least one optical element, and the optical element included in the second optical assembly 30 is arranged in the second accommodation cavity 14 along the second axial direction AX2, and abuts against an inner wall of the second accommodation cavity 14 along the second radial direction, where the second radial direction is a direction perpendicular to the second axial direction AX2. The optical element included in the second optical assembly 30 abuts against the inner wall of the second accommodation cavity 14, which can prevent the optical element included in the second optical assembly 30 from moving in the second accommodation cavity 14 along the second radial direction. The second restrictive assembly 50 is connected to the inner wall of the second accommodation cavity 14 and is configured to restrict the optical element included in the second optical assembly 30, to prevent the optical element included in the second optical assembly 30 from moving in the second accommodation cavity 14 along the second axial direction AX2.

As shown in FIG. 1, in an embodiment, the second axial direction AX2 is parallel to the first axial direction AX1. In other examples, there may also be an angle between the second axial direction AX2 and the first axial direction AX1, which can be designed according to actual needs and is not limited in the application.

The bracket 10 is also configured to provide mounting space for the optical element included in the second optical assembly 30, and the bracket 10 made of the opaque material also prevents light from passing through the bracket 10 and being emitted to the optical element in the second optical assembly 30.

In some embodiments, the second optical assembly 30 is a collection of optical elements. The second optical assembly 30 may include one or more optical elements. In some embodiments, the optical elements in the second optical assembly 30 include lenses, and when the optical elements in the second optical assembly 30 include lenses, the lenses may include a convex lens, a concave lens, a spherical mirror and, an aspheric mirror.

In the optical system 1 provided in an embodiment, the second accommodation cavity 14 of the bracket 10 is used to provide mounting space for the second optical assembly 30, and the optical element in the second optical assembly 30 is positioned through the second restrictive assembly 50, so that the second optical assembly 30 can also be directly mounted on the bracket 10. That is, the bracket 10 reuses a function of two lens barrels. In the related art, the optical system requires the independent production of two independent lens barrels to install the first optical assembly 20 and the second optical assembly 30, and then the lens barrels installed with the first optical assembly 20 and the second optical assembly 30 are installed on the bracket 10. Embodiments of this application can further simplify the production and assembly processes of the optical system and reduce the number of parts in the optical system, thereby reducing the production costs.

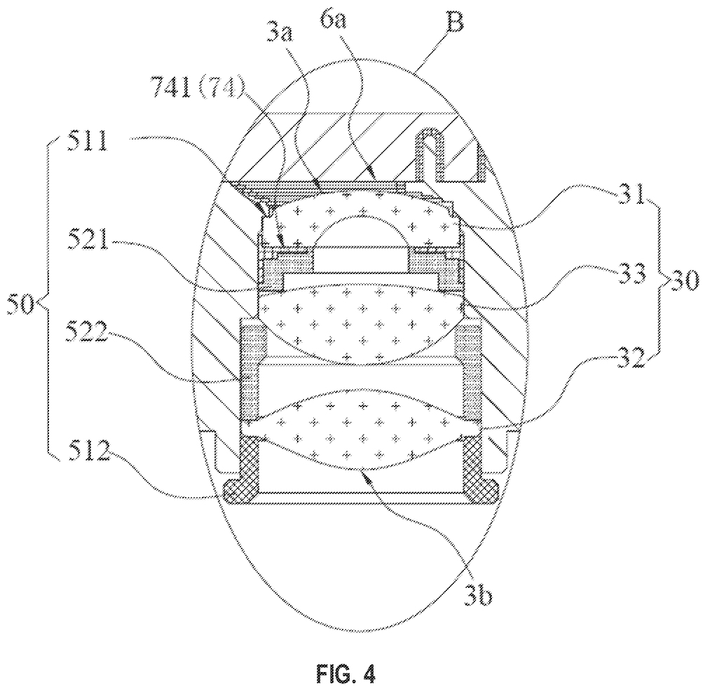

Referring to FIG. 1 and FIG. 4, in an embodiment, the optical system 1 includes two second optical assemblies 30. Correspondingly, the bracket 10 is provided with two second accommodation cavities 14, and the optical system 1 includes two second restrictive assemblies 50 corresponding to two second optical assemblies 30. In some embodiments, the optical system 1 may include one or multiple second optical assemblies 30 (hereinafter, “multiple” means “two or more than two”). Correspondingly, the bracket 10 is provided with one or multiple second accommodation cavities 14 in a one-to-one correspondence with the one or multiple second optical assemblies 30; and the optical system 1 includes one or multiple second restrictive assemblies 50 in a one-to-one correspondence with the one or multiple second optical assemblies 30.

Referring to FIG. 1 and FIG. 4, the second optical assembly 30 includes one or multiple lenses (for example, the third lens 31, the fourth lens 32, and the second middle lens group 33 in FIG. 4). The second optical assembly 30 has a third optical surface 3a and a fourth optical surface 3b, where each lens in the second optical assembly 30 includes two optical surfaces disposed opposite each other along the first axial direction AX1, and light can enter through one of the two optical surfaces disposed opposite each other and exit from the other of the two optical surfaces disposed opposite each other. The third optical surface 3a is an optical surface at the first position when the lenses included in the second optical assembly 30 are arranged along the second axial direction AX2, and the fourth optical surface 3b is an optical surface at the last position when the lenses included in the second optical assembly 30 are arranged along the second axial direction AX2.

In some embodiments, when the second optical assembly 30 includes one lens, the third optical surface 3a and the fourth optical surface 3b are two optical surfaces disposed opposite each other in the same lens. When the second optical assembly 30 includes multiple lenses, the two optical surfaces disposed opposite each other in each lens along the second axial direction AX2 are respectively denoted as the first optical surface and the second optical surface of the lens. The third optical surface 3a is a first optical surface of a lens at the first position when the multiple lenses are arranged along the second axial direction AX2, and the fourth optical surface 3b is a second optical surface of a lens at the last position when the multiple lenses are arranged along the second axial direction AX2.

As shown in FIG. 2, the inner wall of the second accommodation cavity 14 is disposed to form a complete circle, and the inner wall of the second accommodation cavity 14 includes a third inner wall portion 141, a second middle inner wall portion 143 and a fourth inner wall portion 142 arranged along the second axial direction AX2. As shown in FIG. 4, the second restrictive assembly 50 includes a third restrictive member 511 and a fourth restrictive member 512. The third restrictive member 511 is connected to the third inner wall portion 141 of the second accommodation cavity 14. The fourth restrictive member 512 is connected to the fourth inner wall portion 142. The lenses included in the second optical assembly 30 are sequentially arranged in the accommodation space enclosed by the second middle inner wall portion 143 along the second axial direction AX2, the third optical surface 3a of the second optical assembly 30 abuts against the third restrictive member 511, and the fourth optical surface 3b of the second optical assembly 30 abuts against the fourth restrictive member 512.

The third restrictive member 511 is configured to restrict the second optical assembly 30, to prevent the lenses included in the second optical assembly 30 from detaching from the second accommodation cavity 14 through the accommodation space defined by the third inner wall portion 141. The fourth restrictive member 512 is configured to restrict the lenses included in the second optical assembly 30, to prevent the lenses included in the second optical assembly 30 from detaching from the second accommodation cavity 14 through the accommodation space defined by the fourth inner wall portion 142.

Further, the third restrictive member 511 is disposed around the third inner wall portion 141, and a light-transmitting through hole is also provided in the middle of the third restrictive member 511. The light-transmitting through hole of the third restrictive member 511 is configured to allow light to pass through. The fourth restrictive member 512 is disposed around the fourth inner wall portion 142, and a light-transmitting through hole is also provided in the middle of the fourth restrictive member 512. The light-transmitting through hole of the fourth restrictive member 512 is configured to allow light to pass through.

Further, when the second optical assembly 30 includes multiple lenses, the second restrictive assembly 50 further includes a space. One spacer is disposed between each two adjacent lenses in the multiple lenses included in the second optical assembly 30. Two ends of the spacer disposed between the two adjacent lenses along the second axial direction AX2 respectively abut against the two corresponding adjacent lenses, and are configured to space the two adjacent lenses apart. An outer side wall of the spacer disposed between the two adjacent lenses abuts against the second middle inner wall portion 143 along the second radial direction, to prevent the spacer from moving along the second radial direction. For example, the second optical assembly 30 includes N lenses disposed along the second axial direction AX2, where N is a positive integer greater than or equal to 2. The second restrictive assembly 50 further includes N−1 spacers. An (n−1)^{th} spacer is disposed between an (n−1)^{th} lens and an n^{th} lens, where n is a positive integer, and 2≤n≤N. Two ends of the (n−1)^{th} spacer along the second axial direction AX2 respectively abut against a second optical surface of the (n−1)^{th} lens and a first optical surface of the n^{th} lens, and are configured to space the (n−1)^{th} lens and the n^{th} lens apart. An outer side wall of the (n−1)^{th} spacer abuts against the second middle inner wall portion 143 of the second accommodation cavity 14 along the second radial direction, to prevent the (n−1)^{th} spacer from moving along the second radial direction. The (n−1)^{th} spacer is also provided with a light-transmitting through hole to allow light between the (n−1)^{th} lens and the nth lens to pass through.

In an embodiment, a principle of restricting the lenses included in the second optical assembly 30 by the second restrictive assembly 50 is as follows: the lenses included in the second optical assembly 30 and the spacers included in the second restrictive assembly 50 abut against the second middle inner wall portion 143 of the second accommodation cavity 14 along the second radial direction, and therefore, the lenses included in the second optical assembly 30 and the second spacers included in the second restrictive assembly 50 cannot move in the second accommodation cavity 14 in the second radial direction, but can move only along the second axial direction AX2. The third restrictive member 511 and the fourth restrictive member 512 restrict the third optical surface 31a and the fourth optical surface 32b of the second optical assembly 30 to confine the lenses included in the second optical assembly 30 to the second accommodation cavity 14. The spacer disposed between each two adjacent lenses can provide support for the two adjacent lenses, so that each lens is disposed at preset intervals, thereby fixing the lenses included in the second optical assembly 30 into the second accommodation cavity 14. As shown in FIG. 4, in a specific embodiment, the second optical assembly 30 includes a third lens 31, a second middle lens group 33 and a fourth lens 32 arranged sequentially along the second axial direction AX2, where the second middle lens group 33 includes a fourth middle lens 331 arranged sequentially along the second axial direction AX2. The third restrictive member 511 is connected to the third inner wall portion 141 and abuts against the first optical surface (for example, the third optical surface 3a shown in FIG. 4) of the third lens 31, to prevent three lenses included in the second optical assembly 30 from detaching from the second accommodation cavity 14 through the accommodation space defined by the third inner wall portion 141. The fourth restrictive member 512 is connected to the fourth inner wall portion 142 and abuts against the second optical surface (for example, the second optical surface 3b shown in FIG. 4) of the fourth lens 32, to prevent the three lenses included in the second optical assembly 30 from detaching from the second accommodation cavity 14 through the accommodation space defined by the fourth inner wall portion 142.

Referring to FIG. 4, the second restrictive assembly 50 further includes a fifth spacer 521 and a sixth spacer 522. The fifth spacer 521 is disposed between the second optical surface of the third lens 31 and the second optical surface of the fourth middle lens 331, and is configured to provide support for the third lens 31 and the fourth middle lens 331, thereby spacing the third lens 31 and the fourth middle lens 331 apart. The sixth spacer 522 is disposed between the second optical surface of the fourth middle lens 331 and the first optical surface of the fourth lens 332, and is configured to provide support for the fourth middle lens 331 and the fourth lens 332, thereby spacing the fourth middle lens 331 and the fourth lens 332 apart.

Further, a light-transmitting through hole of the third restrictive member 511 is configured to allow light corresponding to the third lens 31 to pass through. A light-transmitting through hole of the fifth spacer 521 is configured to allow light to be transmitted between the third lens 31 and the fourth middle lens 331. A light-transmitting through hole of the sixth spacer 522 is configured to allow light to be transmitted between the fourth middle lens 331 and the fourth lens 332. A light-transmitting through hole of the sixth spacer 522 is configured to allow light to be transmitted between the fourth middle lens 331 and the fourth lens 332, and a light-transmitting through hole of the fourth restrictive member 512 is configured to allow light corresponding to the second lens 22 to pass through.

Referring to FIG. 2, in an embodiment, the second middle inner wall portion 143 includes a third inner wall sub-portion 1431, a second main inner wall portion 1433, and a fourth inner wall sub-portion 1432 arranged sequentially along the second axial direction AX2. A dimension of the third inner wall sub-portion 1431 along the second radial direction is less than that of the second main inner wall portion 1433, and a dimension of the second main inner wall portion 1433 along the second radial direction is less than that of the fourth inner wall sub-portion 1432. The third restrictive member 511 is integrally formed with the bracket 10. The fourth restrictive member 512 and the bracket 10 are two parts that are independently processed. When the lens included in the second optical assembly 30 needs to be mounted into the second accommodation cavity 14, the accommodation space defined by the fourth inner wall portion 142 is first used as an entrance, to put the lens included in the second optical assembly 30 and the spacer included in the second restrictive assembly 50 into the second accommodation cavity 14 sequentially. After the lens included in the second optical assembly 30 and the spacer included in the second restrictive assembly 50 are sequentially put into the second accommodation cavity 14 through the accommodation space defined by the fourth inner wall portion 142, the fourth restrictive assembly 512 is put into the second accommodation cavity 14 and is connected to the second inner wall portion 142.

In an embodiment, the third restrictive member 511 is an annular bulge formed by recessing the third inner wall portion 141 into the second accommodation cavity 14. External threads are disposed on an outer side wall of the fourth restrictive member 512, and internal threads are disposed on the fourth inner wall portion 142. The fourth restrictive member 512 and the fourth inner wall portion 142 are connected through threads. In some embodiments, the fourth restrictive member 512 is welded to the fourth inner wall portion 142. In some embodiments, the fourth restrictive member 512 can be connected to the fourth inner wall portion 142 through ultrasonic welding or laser welding.

In some embodiments, the third restrictive member 511 and the bracket 10 may also be two parts that are processed independently. External threads are disposed on an outer side wall of the third restrictive member 511, and internal threads are disposed on the third inner wall portion 141. The third restrictive member 511 and the third inner wall portion 141 are connected through threads. In some embodiments, the third restrictive member 511 may be welded to the third inner wall portion 141. In some embodiments, the third restrictive member 511 can be connected to the third inner wall portion 141 through ultrasonic welding or laser welding. At this time, when the lens included in the second optical assembly 30 needs to be mounted into the second accommodation cavity 14, the third restrictive assembly 511 is first put into the second accommodation cavity 14 and connected to the third inner wall portion 141, and then the accommodation space defined by the fourth inner wall portion 141 is used as an entrance, to put the lens included in the second optical assembly 30 and the second spacer included in the second restrictive assembly 50 into the second accommodation cavity 14 sequentially. After the lens included in the second optical assembly 30 and the second spacer included in the second restrictive assembly 50 are sequentially put into the second accommodation cavity 14 through the accommodation space defined by the fourth inner wall portion 142, the fourth restrictive assembly 512 is put into the second accommodation cavity 14 and is connected to the second inner wall portion 142 through, for example, threaded or welded connection.

Referring to FIG. 2, the light-transmitting sheet 60 is further configured to provide protection for the second optical assembly 30 mounted on the bracket 10 and is further configured to allow light corresponding to the second optical assembly 30 to pass through. When the second optical assembly 30 is configured to emit light, the light emitted by the second optical assembly 30 can be emitted outward through the light-transmitting sheet 60; and when the second optical assembly 30 is configured to receive light, external light can pass through the light-transmitting sheet 60 to enter the second optical assembly 30.

Referring to FIG. 1, FIG. 2, and FIG. 5, the first end surface 11 of the bracket 10 is provided with a second through hole 11b that communicates with the second accommodation cavity 14, and the first end surface 11 of the bracket 10 has a second sealing path 112, and the second sealing path 112 is disposed around a circumferential side of the second through hole 11b. Referring to FIG. 1 and FIGS. 4-5, the optical system 1 further includes a third sealed connection structure 73 and a fourth sealed connection structure 74, and the third sealed connection structure 73 is configured to form a sealed connection between the second sealing path 112 and the first light-transmitting surface 6a, and the fourth sealed connection structure 74 is configured to form a sealed connection between the second optical element (for example, the third lens 31 in FIG. 4) and the inner wall of the second accommodation cavity 14. The second optical element is an optical element (for example, the third lens 31 in FIG. 4) at the first position when optical elements included in the second optical assembly 30 are arranged along the second axial direction AX2. The third sealed connection structure 73 and the fourth sealed connection structure 74 can form a sealed second compartment 62 between the light-transmitting sheet 60 and the second optical element of the second optical assembly 30.

In the related art, when no independent second compartment 62 is formed between the light-transmitting sheet 60 and the second optical element, and as a result, a large amount of water vapor on the side of the light-transmitting sheet 60 that is closer to the second optical element can come into contact with the first light-transmitting surface 6a of the light-transmitting sheet 60. Water vapor easily forms condensation (water droplets formed after pre-cooling and condensation of water vapor) on the first light-transmitting surface 6a of the light-transmitting sheet 60, and the light is refracted and deviates from an original optical path when passing through the condensation, thereby affecting a detection effect when the light (for example, a laser beam) is used for detection. In the optical system 1 provided in the embodiments of this application, a sealed second compartment 62 is formed between the light-transmitting sheet 60 and the second optical element, which can reduce an amount of water vapor in contact with the first light-transmitting surface 6a of the light-transmitting sheet 60, so that a condensation phenomenon caused because water vapor condenses on the first light-transmitting surface 6a of the light-transmitting sheet 60 can be effectively alleviated. In addition, when the optical system 1 is applied to the LiDAR, the bracket 10 is mounted on the housing 8 of the LiDAR. An accommodation cavity 81 is formed between the second end surface 12 of the bracket 10 and the housing 8. A circuit system of the LiDAR is disposed in the accommodation cavity 81, and during working of the circuit system, a large amount of heat is generated, thereby causing higher water vapor temperature in the accommodation cavity 81 when the LiDAR is working. If no independent second compartment 62 is formed between the light-transmitting sheet 60 and the second optical element, the hot water vapor can come into contact with the first light-transmitting surface 6a of the light-transmitting sheet 60 through the second accommodation cavity 14, and the light-transmitting sheet 60 is close to external air and is at lower temperature, and when the hot water vapor comes into contact with the first light-transmitting surface 6a of the light-transmitting sheet 60, the condensation phenomenon is more likely to appear.

Referring to FIGS. 5-7, in some embodiments, the third sealed connection structure 73 includes a third sealing bulge 731, a third sealing groove 732, and a third sealing rubber ring 733. The third sealing bulge 731 is disposed on the first end surface 11 along the second sealing path 112. The third sealing groove 732 is disposed on the first light-transmitting surface 6a of the light-transmitting sheet 60 and corresponds to the third sealing bulge 731. The third sealing rubber ring 733 is filled inside the third sealing groove 732. The third sealing bulge 731 is embedded in the third sealing groove 732 and seal-connected to the third sealing groove 731 through the third sealing rubber ring 733, thereby implementing sealed connection between the second sealing path 112 of the first end surface 11 and the first light-transmitting surface 6a of the light-transmitting sheet 60.

Referring to FIG. 5, in an embodiment, the third sealing bulge 731 is integrally formed with the bracket 10, which not only can better ensure a sealing effect, but also facilitates processing. In some embodiments, the third sealing bulge 731 and the bracket 10 are two parts that are independently formed, and the third sealing bulge 731 can be connected to the second sealing path 112 on the bracket 10 through welding or glue binding, thereby ensuring the sealing effect.

Further, the third sealing bulge 731 is made of an opaque material. In an embodiment, the bracket 10 is made of an opaque material, and correspondingly, the third sealing bulge 731 integrally formed with the bracket 10 is also made of an opaque material. The third sealing bulge 731 is made of the opaque material, which can improve light blocking performance of the second compartment 62 and reduce a probability of entering the second optical assembly 30 by stray light. The stray light includes light outside a preset optical path range of the second optical assembly 30. In some embodiments, the stray light may include light formed by light outside the preset optical path range of the second optical assembly 30 that enters the second optical assembly 30 located in the second accommodation cavity 14 after being reflected by the light-transmitting sheet 60. The preset optical path range of the second optical assembly 30 refers to a range that is preset by a technician when designing the optical path of the second optical assembly 30 and that can be covered by incident light and outgoing light of the second optical assembly 30.

In some embodiments, the third sealing groove 732 is disposed on the first end surface 11 along the second sealing path 112, and the third sealing bulge 731 is disposed on the first light-transmitting surface 6a and corresponds to the third sealing groove 732. The third sealing rubber ring 733 is filled inside the third sealing groove 732. The third sealing bulge 731 is embedded in the third sealing groove 732 and seal-connected to the third sealing groove 732 through the third sealing rubber ring 733, thereby implementing sealed connection between the second sealing path 112 of the first end surface 11 and the first light-transmitting surface 6a of the light-transmitting sheet 60. Further, the third sealing bulge 731 may be integrally formed with the light-transmitting sheet 60.

In some embodiments, the third sealed connection structure 73 includes a second welded connection structure, and the second welded connection structure is a welded structure formed after the first end surface 11 and the first light-transmitting surface 6a are welded along the second sealing path 112.

In an embodiment, the bracket 10 and the light-transmitting sheet 60 are made of PC (polycarbonate) plastic, and the second welded connection structure can be a welded structure formed by welding the first end surface 11 and the first light-transmitting surface 6a along the second sealing path 112 through ultrasonic welding, thereby forming the sealed connection between the second sealing path 112 and the first lens surface 61. In some embodiments, the bracket 10 can also be made of other types of opaque plastic materials, and the light-transmitting sheet 60 can also be made of other types of plastic materials that can transmit light, provided that the bracket 10 and the light-transmitting sheet 60 can be connected through ultrasonic welding.

In an embodiment, the light-transmitting sheet 60 is made of the light-transmitting material, and the bracket 10 is made of the opaque material. The second welded connection structure can be formed by welding the first end surface 11 and the first light-transmitting surface 6a along the second sealing path 112 through laser welding, thereby forming the sealed connection between the second sealing path 112 and the first lens surface 61. At this time, the bracket 10 and the light-transmitting sheet 60 can be connected through laser welding. This application does not limit the material of the bracket 10 and the light-transmitting sheet 60.

Referring to FIG. 4, in an embodiment, the fourth sealed connection structure 74 includes a fourth sealing rubber ring 741. A dimension of the second optical element along the radial direction is less than a dimension of the spacer for supporting the second optical element along the radial direction. The fourth sealing rubber ring 741 is filled in space defined by the second optical surface of the second optical element, the second spacer for supporting the first optical element (for example, the fifth spacer 521 in FIG. 4) and the second middle inner wall portion 143, to bind the second optical element with the second middle inner wall portion 143 of the second accommodation cavity 14, thereby implementing sealed connection between the second optical element and the inner wall of the second accommodation cavity 14.

Further, referring to FIG. 4, the outer wall surface of the spacer for supporting the second optical element is step-shaped, and the fourth sealing rubber ring 741 is filled in the step-shaped space, which increases a contact area between the fourth sealing rubber ring 741 and the second middle inner wall portion 143, thereby facilitating improvement of the sealing effect of the fourth sealing rubber ring 741.

Referring to FIG. 2, the inner wall of the second accommodation cavity 14 further includes a second light blocking inner wall 144. The second light blocking inner wall 144 is located between the second through hole 11b and the side of the second optical assembly 30 that is closer to the second through hole 11b. Space defined by the second light blocking inner wall 144 is configured to allow light within the preset optical path range to enter or exit the second optical assembly 30.

Further, at least part of a wall surface of the second light blocking inner wall 144 is provided with multiple second light blocking grooves 144 arranged in sequence. Large-angle stray light that is at an angle outside the preset receiving optical path range of the second optical assembly 30 and that is emitted toward the second light blocking inner wall 144 can be reflected by the second light blocking groove 144, which can effectively dissipate energy of the large-angle stray light, thereby further reducing impact of the large-angle stray light on the optical system 1.

In some embodiments, the second light blocking inner wall 144 is disposed between the second through hole 11b and the third inner wall portion 141, and the multiple second light blocking grooves 144 arranged in sequence are step-shaped.

Referring to FIG. 5, the first sealing path 111 and the second sealing path 112 that are disposed adjacently have a common sealing section 1112. Correspondingly, as shown in FIG. 5, the first sealing bulge 711 disposed along the first sealing path 111 and the second sealing bulge 731 disposed along the second sealing path 112 have a common bulge section 7131. Correspondingly, as shown in FIG. 5, the first sealing groove 712 and the second sealing groove 732 disposed on the first light-transmitting surface 6a have a common groove section 7132. In the optical system 1 in embodiments, using the common sealing section 1112 can reduce length of a sealing bulge that needs to be processed on the first end surface 11 and length of the sealing groove that needs to be processed on the first light-transmitting surface 6a, thereby facilitating processing.

Referring to FIG. 5, the first end surface 11 of the bracket 10 has a third sealing path 113, and the third sealing path 113 is disposed around the first sealing path 111 and the second sealing path 112. Referring to FIG. 1, the optical system 1 also includes a fifth sealed connection structure 75, and the fifth sealed connection structure 75 is configured to form a sealed connection between the third sealing path 113 and the first light-transmitting surface 6a, to further isolate water vapor.

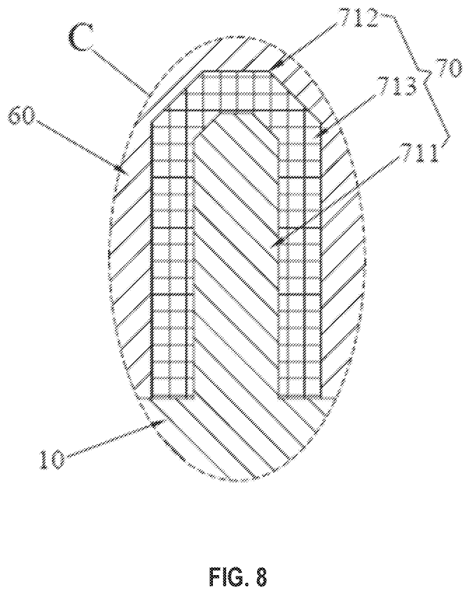

Referring to FIG. 5, FIG. 6, and FIG. 8, in some embodiments, the fifth sealed connection structure 75 includes a fifth sealing bulge 751, a fifth sealing groove 752, and a fifth sealing rubber ring 753. The fifth sealing bulge 751 is disposed on the first end surface 11 along the third sealing path 113. The fifth sealing groove 752 is disposed on the first light-transmitting surface 6a of the light-transmitting sheet 60 and corresponds to the fifth sealing bulge 751. The fifth sealing rubber ring 753 is filled inside the fifth sealing groove 752. The fifth sealing bulge 751 is embedded in the fifth sealing groove 752, and is seal-connected to fifth sealing groove 752 through the fifth sealing rubber ring 753, thereby implementing sealed connection between the third sealing path 113 of the first end surface 11 and the first light-transmitting surface 6a of the light-transmitting sheet 60.

Referring to FIG. 5, in an embodiment, the fifth sealing bulge 751 is integrally formed with the bracket 10, which not only can better ensure a sealing effect, but also facilitates processing. In some embodiments, the fifth sealing bulge 751 and the bracket 10 are two parts that are independently formed, and the fifth sealing bulge 751 can be connected to the third sealing path 113 on the bracket 10 through welding or glue binding, thereby ensuring the sealing effect.

Further, the fifth sealing bulge 751 is made of an opaque material. In an embodiment, the bracket 10 is made of an opaque material, and correspondingly, the fifth sealing bulge 751 integrally formed with the bracket 10 is also made of an opaque material. The fifth sealing bulge 751 is made of the opaque material, which can improve light blocking performance of the second compartment 62 and reduce a probability of entering the first optical assembly 20 and the second optical assembly 30 by stray light. The stray light includes light outside a preset optical path range of the first optical assembly 20 and the second optical assembly 30. In some embodiments, the stray light may include light formed by light outside the preset optical path range of the first optical assembly 20 and the second optical assembly 30 that enters the first accommodation cavity 13 and the second accommodation cavity 14 after being reflected by the light-transmitting sheet 60. The preset optical path range of the first optical assembly 20 and the second optical assembly 30 refers to a range that is preset by a technician when designing the optical path of the first optical assembly 20 and the second optical assembly 30 and that can be covered by incident light and outgoing light of the first optical assembly 20 and the second optical assembly 30.

In some embodiments, the fifth sealing groove 752 is disposed on the first end surface 11 along the third sealing path 113, and the fifth sealing bulge 751 is disposed on the first light-transmitting surface 6a and corresponds to the fifth sealing groove 752. The fifth sealing rubber ring 753 is filled inside the fifth sealing groove 752. The fifth sealing bulge 751 is embedded in the fifth sealing groove 752, and is seal-connected to the fifth sealing groove 752 through the fifth sealing rubber ring 753, thereby implementing sealed connection between the third sealing path 113 of the first end surface 11 and the first light-transmitting surface 6a of the light-transmitting sheet 60. Further, the fifth sealing bulge 751 may be integrally formed with the light-transmitting sheet 60.

In some embodiments, the fifth sealed connection structure 75 includes a third welded connection structure, and the third welded connection structure is a welded structure formed after the first end surface 11 and the first light-transmitting surface 6a are welded along the third sealing path 113.

In an embodiment, the bracket 10 and the light-transmitting sheet 60 are made of PC (polycarbonate) plastic, and the third welded connection structure can be a welded structure formed by welding the first end surface 11 and the first light-transmitting surface 6a along the third sealing path 113 through ultrasonic welding, thereby forming the sealed connection between the third sealing path 113 and the first lens surface 61. In an example, the bracket 10 can also be made of other types of opaque plastic materials, and the light-transmitting sheet 60 can also be made of other types of plastic materials that can transmit light, provided that the bracket 10 and the light-transmitting sheet 60 can be connected through ultrasonic welding.

In an embodiment, the light-transmitting sheet 60 is made of the light-transmitting material, and the bracket 10 is made of the opaque material. The third welded connection structure can be formed by welding the first end surface 11 and the first light-transmitting surface 6a along the third sealing path 113 through laser welding, thereby forming the sealed connection between the third sealing path 113 and the first lens surface 61. At this time, it is required that the bracket 10 and the light-transmitting sheet 60 can be connected through laser welding. This application does not limit the material of the bracket 10 and the light-transmitting sheet 60.

As shown in FIG. 5, in an embodiment, the number of third sealing paths 113 is one. In some embodiments, the number of third sealing paths 113 may also be multiple, and multiple third sealing paths 113 may be spaced apart to enable multi-layer sealing, thereby further improving the sealing effect and reducing the amount of water vapor entering the first compartment 61 and the second compartment 62.

Referring to FIG. 1, the first light-transmitting surface 6a and the first end surface 11 are attached to each other, which can further reduce volumes of the first compartment 61 and the second compartment 62, thereby reducing an amount of water vapor that can be accommodated in the first compartment 61 and the second compartment 62 and facilitating further reduction in a probability that the water vapor inside the first compartment 61 and the second compartment 62 condenses into condensation on the first light-transmitting surface 6a.

As shown in FIG. 11 to FIG. 13, according to a second aspect, embodiments of this application also provide a LiDAR. The LiDAR includes the optical system 1 in any one of the foregoing embodiments. The LiDAR also includes a housing 8, a light-emitting module 3, and a detection module 2. The housing 8 is connected to the second end surface 12 of the bracket 10. After the housing 8 is connected to the second end surface 12, an accommodation cavity 81 is formed.

The light-emitting module 3 is disposed in the accommodation cavity 81. The second optical assembly 30 is located on a light-emitting side of the light-emitting module 3 and is configured to receive the laser beam emitted by the light-emitting module 3 and emit an outgoing laser beam to the detection region. Further, the detection module 2 is disposed in the accommodation cavity 81. The first optical assembly 20 is located on a light incident side of the detection module 2 and is configured to receive an echo laser beam returned after the outgoing laser beam is reflected by an obstacle in the detection region and focus the echo laser beam on the detection module 2. The LiDAR provided in this embodiment emits a laser beam through the light-emitting module 3, and then the first optical assembly 20 receives the laser beam emitted by the light-emitting module 3, to emit the outgoing laser beam to the detection region. Then the echo laser beam is received through the detection module 2. The echo laser beam is converted into an electrical signal, and then a signal processing part of the LiDAR processes the electrical signal appropriately, to form a point cloud map. By processing the point cloud map, a distance, an azimuth, a height, a speed, an attitude and a shape and other parameters of the target object can be obtained, thereby implementing a laser detection function, which can be applied to navigation avoidance, obstacle recognition, ranging, speed measurement, autonomous driving and other scenarios of an automobile, a robot, a logistics vehicle, a patrol vehicle and other products.

Referring to FIGS. 11-13, in an embodiment, the LiDAR includes two light-emitting modules 3 and a detection module 2, and the two light-emitting modules 3 are respectively located on two sides of the detection module 2. Correspondingly, the optical system 1 includes two second optical assemblies 30 in a one-to-one correspondence with the two light-emitting modules 3, and also includes one first optical assembly 20 corresponding to one detection module 2. The two second optical assemblies 30 are disposed on two sides of the first optical assembly 20. The first optical assembly 20 has a first optical axis 2 and the second optical assembly 30 has a third optical axis 3a.

Referring to FIG. 11, in an embodiment, along the horizontal direction X-X, each of the two light-emitting modules 3 is located on a side of the first optical axis 2 of a corresponding first optical assembly 20 that is farther away from the second optical assembly 30. Based on the principle of optical imaging, after receiving laser beams emitted by the corresponding light-emitting modules 3, the two second optical assemblies 30 guide a laser beam L toward a side of the first optical axis 2 that is closer to the second optical assembly 30, so that the laser beams emitted by the two second optical assemblies 30 have an overlapped region in the middle, to reduce a detection blind region of the LiDAR. In addition, when the LiDAR performs short-distance detection, even if there is pixel offset, the central field of view of the LiDAR is still illuminated by the laser beam, which can effectively avoid a lack of point clouds in the central field of view of the LiDAR.

A combination of emission angles of view covered by the laser beams emitted by the two second optical assemblies 30 matches a receiving angle of view covered by the laser beam received by the first optical assembly 20, so that the first optical assembly 20 can receive echo laser beams R formed after the laser beams L emitted by the two second optical assemblies 30 to the detection region are reflected by an obstacle in the detection region. The LiDAR provided in this application splices the emission angles of view by using two light-emitting modules 3 and two second optical assemblies 30, which not only facilitates enlargement of the detection angle of view of the LiDAR, but also facilitates the reduction in a size of each light-emitting module 3, thereby facilitating reduction in costs of the used light-emitting module 3.

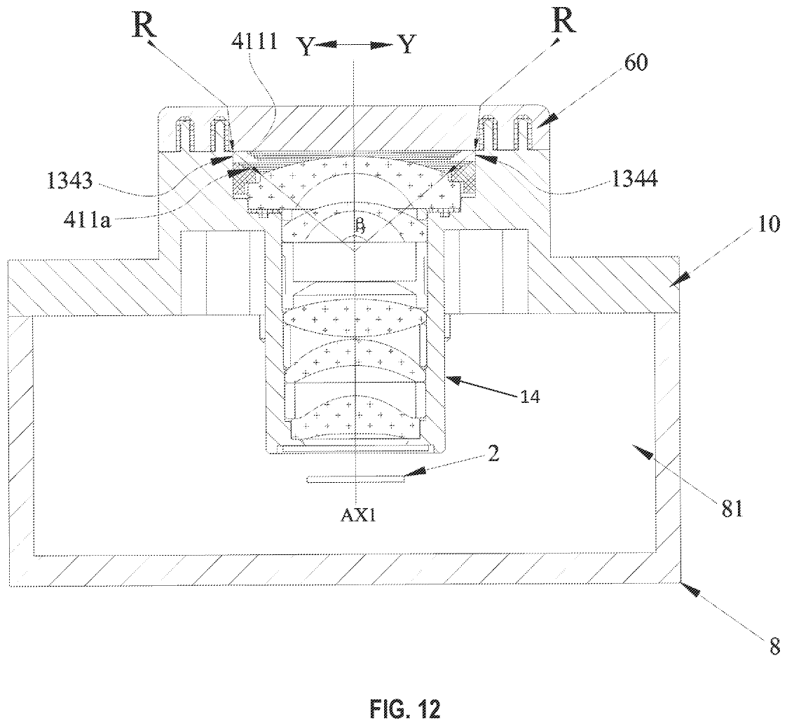

In some embodiments, as shown in FIG. 11, along the horizontal direction X-X, a horizontal emission angle of view covered by a laser beam emitted by a second optical assembly 30 on the left is 0 to +αₓ, and a horizontal emission angle of view covered by a laser beam emitted by a second zc optical assembly 30 on the right is −αₓ to 0. A combination of the horizontal emission angles of view covered by the laser beams emitted by the two second optical assemblies 30 is −αₓ to +αₓ, and a horizontal receiving angle of view covered by the laser beam received by the first optical assembly 20 is −(βₓ/2) to +(βₓ/2), where βₓ=2*αₓ. As shown in FIG. 12, along the vertical direction Y-Y, a vertical receiving angle of view covered by a laser beam received by the first optical assembly 20 is −(β_{y}/2) to +(β_{y}/2). A vertical emission angle of view covered by a laser beam emitted by the second optical assembly 30 is −(α_{y}/2) to +(α_{y}/2), where β_{y}=α_{y}.

As shown in FIGS. 11-12, the first light blocking inner wall 134 includes a first light blocking wall surface 1341 and a second light blocking wall surface 1342 symmetrically disposed along the horizontal direction, and a third light blocking wall surface 1343 and a fourth light blocking wall surface 1344 symmetrically disposed along the vertical direction. Space defined between the first light blocking wall surface 1341 and the second light blocking wall surface 1342 is used to allow light within a preset receiving optical path range to enter the first optical assembly 20 along the horizontal direction X-X. Space defined between the third light blocking wall surface 1343 and the fourth light blocking wall surface 1344 is used to allow light within the preset receiving optical path range to enter the first optical assembly 20 along the vertical direction Y-Y.

In an embodiment, the first light blocking wall surface 1341 and the second light blocking wall surface 1342 form angles with the first axial direction AX1, and an included angle between the first light blocking wall surface 1341 and the first axial direction AX1 is equal to −(βₓ/2) to 0. An included angle between the second light blocking inner wall 1342 and the first axial direction AX1 is equal to 0 to +(βₓ/2). The third light blocking wall surface 1343 and the fourth light blocking wall surface 1344 are arranged parallel to the first axial direction AX1.

In some embodiments, the first light blocking wall surface 1341 and the second light blocking wall surface 1342 may further be arranged parallel to the first axial direction AX1. The third light blocking wall surface 1343 and the fourth light blocking wall surface 1344 form angles with the first axial direction AX1. An included angle between the third light blocking wall surface 1341 and the first axial direction AX1 is equal to −(β_{y}/2) to 0, and an included angle between the fourth light blocking wall surface 1344 and the first axial direction AX1 is equal to 0 to +(β_{y}/2).

As shown in FIG. 11 multiple first light blocking grooves 134 are sequentially arranged along a wall surface extension direction of the first light blocking wall surface 1341 and the second light blocking wall surface 1342. As shown in FIG. 11, an inner wall 4111 of the first restrictive member 411 is engaged with the first light blocking inner wall 134, and multiple third light blocking grooves 411a are disposed along a wall surface extension direction of the inner wall 4111 of the first restrictive member 411. Multiple third light blocking grooves 411a disposed on the inner wall 4111 of the first restrictive member 411 are engaged with the first light blocking grooves 134 on the first light blocking wall surface 1341 and the second light blocking wall surface 1342. In some embodiments, the multiple third light blocking grooves 411a disposed in sequence are step-shaped, and the multiple third light blocking grooves 411a disposed in sequence are engaged with the step-shaped first light blocking grooves 134. Referring to FIG. 5, an edge line of the first through hole 11a on the first end surface 11 includes a first circular arc section 101, a second circular arc section 102, a third circular arc section 103, and a fourth circular arc section 104. The first circular arc section 101 and the second circular arc section 102 are partial arcs on a first circle R1, and the first circular arc section 101 and the second circular arc section 102 are symmetrically arranged along the horizontal direction X-X and the vertical direction Y-Y The third circular arc section 103 and the fourth circular arc section 104 are partial arcs on a second circle R2, and the third circular arc section 103 and the fourth circular arc section 104 are symmetrically arranged along the horizontal direction X-X and the vertical direction Y-Y The first circle R1 and the second circle R2 are concentric circles. In addition, because the first optical assembly 10 satisfies that βₓ>β_{y}, the first circle R1 and the second circle R2 satisfy that d1>d2, where d1 and d2 are diameters of the first circle R1 and the second circle R2, respectively. In this embodiment, d1>d2, so that the first optical assembly 10 receives light within the preset optical path range along the horizontal direction X-X and the vertical direction Y-Y.

Further, the third circular arc section 103 has one end connected to the first circular arc section 101 through a first horizontal line section 1031, and has the other end connected to a second circular arc section 102 through a second horizontal line section 1032. The first horizontal line section 1031 and the second horizontal line section 1032 are on a first straight line L1. The fourth circular arc section 104 has one end connected to the first circular arc section 101 through the third horizontal line section 1041, and has the other end connected to the second circular arc section 1042 through the fourth horizontal line section 1042. The third horizontal line section 1041 and the fourth horizontal line section 1042 are on a second straight line L2. In the optical system 1 provided in an embodiment, based on receiving angles of view of the first optical assembly 20 along the horizontal direction X-X and the vertical direction Y-Y, an angle of the first light blocking inner wall 134 and dimensions of the first through hole 11a on the first end surface 11 along the horizontal direction and the vertical direction are designed, so that the dimensions of the first through hole 11a can be reduced while ensuring the receiving effect of the first optical assembly 20, thereby further reducing the probability that stray light enters the first optical assembly 20 through the first through hole 11a.

As shown in FIG. 11, the second light blocking inner wall 144 includes a fifth light blocking wall surface 1441 and a sixth light blocking wall surface 1442 oppositely disposed along the horizontal direction, and a seventh light blocking wall surface 1443 and an eighth light blocking wall surface 1444 symmetrically disposed along the vertical direction. Space defined between the fifth light blocking wall surface 1441 and the sixth light blocking wall surface 1442 is used to allow light emitted by the second optical assembly 30 to be directed out within the preset emission optical path range along the horizontal direction X-X. Space defined between the seventh light blocking wall surface 1443 and the eighth light blocking wall surface 1444 is used to allow light emitted by the second optical assembly 30 to be directed out within the preset emission optical path range along the vertical direction Y-Y.

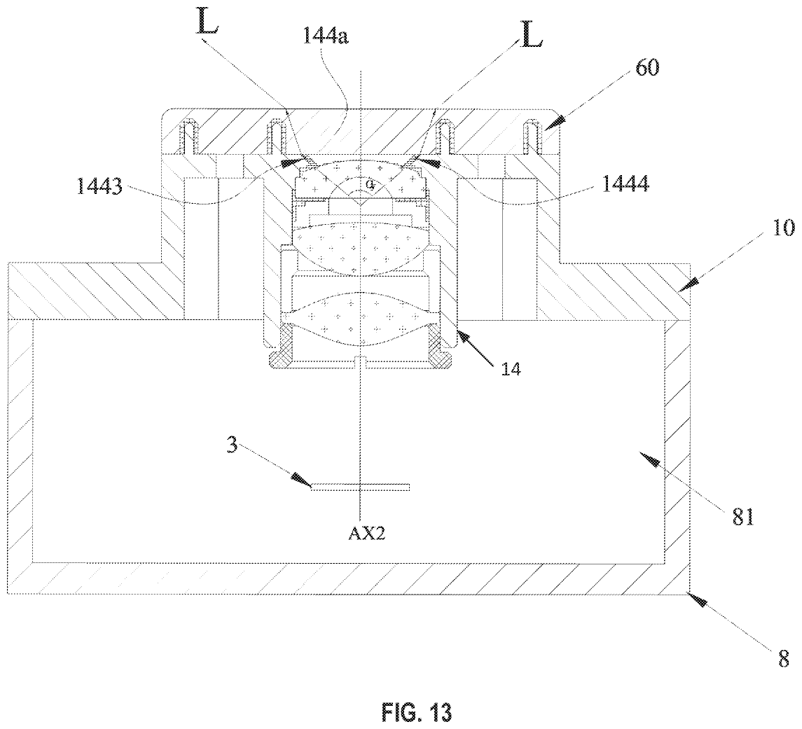

In an embodiment, as shown in FIG. 11, the fifth light blocking wall surface 1441 forms an angle with the second axial direction AX2, and the sixth light blocking wall surface 1442 is arranged parallel to the second axial direction AX2. An included angle between a fifth light blocking wall surface 1441 corresponding to the second optical assembly 30 on the left and the second axial direction AX2 is −(αₓ/2) to 0, and an included angle between a fifth light blocking wall surface 1441 corresponding to the second optical assembly 30 on the right and the second axial direction AX2 is 0 to +(αₓ/2). As shown in FIG. 13, the seventh light blocking wall surface 1443 and the eighth light blocking wall surface 1444 form angles with the second axial direction AX2, an included angle between the seventh light blocking wall surface 1443 and the second axial direction AX2 is −(α_{y}/2) to 0, and an included angle between the eighth light blocking wall surface 1444 and the second axial direction AX2 is 0 to +(α_{y}/2).

In some embodiments, multiple second light blocking grooves 144 are sequentially arranged along a wall surface extension direction of the fifth light blocking wall surface 1441, the seventh light blocking wall surface 1443, and the eighth light blocking wall surface 1444.

As shown in FIG. 5, an edge line of the second through hole 11b on the first end surface 11 includes a fifth line section 105, a sixth line section 106, a seventh line section 107, and an eighth line section 108. The fifth line section 105 and the sixth line section 106 are arranged in parallel, and the seventh line section 107 and the eighth line section 108 are arranged in parallel. The fifth line section 105 is in a one-to-one correspondence with the fifth light blocking wall surface 1441, the sixth light blocking wall surface 1442, the seventh light blocking wall surface 1443, and the eighth light blocking wall surface 1444 respectively. In this embodiment, the second optical assembly 30 guides the laser beam toward a side of the second axial direction AX2 that is closer to the first optical assembly 20, and a distance between the sixth line section 106 and the second axial direction AX2 is less than a distance between the fifth line section 105 and the second axial direction AX2, so that a dimension of the second through hole 11b can be reduced and the receiving effect of the second optical assembly 30 is ensured at the same time, thereby further reducing the probability that stray light enters the second optical assembly 30 through the second through hole 11b. Still referring to FIG. 1 and FIG. 2, the first optical assembly 20 further includes a light filter 24, where the light filter 24 is disposed in the first accommodation cavity 13 and disposed on a side of the second restrictive member 412 that is farther away from the first restrictive member 411. The light filter 24 is configured to select an echo laser beam with required wavelength, and the like. In a specific embodiment, the light filter 24 is bound to the side of the second restrictive member 412 that is farther away from the first restrictive member 411 through glue.

Embodiment 2 is as follows.

As shown in FIGS. 12-13, a difference between this embodiment and Embodiment 1 is as follows. An optical system 1 further includes a second lens barrel for assembling a second optical assembly 30, and the second lens barrel is mounted in the second accommodation cavity 14. The second lens barrel 300 is provided with a second light-transmitting channel. The second light-transmitting channel extends along a second axial direction AX2. Optical elements included in the second optical assembly 30 are arranged in the second light-transmitting channel of the second lens barrel along the second axial direction AX2.

In this embodiment, the number of first optical assemblies 20 is one, and the number of second optical assemblies 30 is one or more than one.

In the optical system 1 provided in this embodiment, the first optical assembly 20 is directly mounted in the first accommodation cavity 13 in the bracket 10, and the second optical assembly 30 is assembled with the second lens barrel 300 as a whole, and then mounted on the bracket 10 through the second lens barrel 300. When the optical system 1 is light-adjusted before assembly, a bracket 10 mounted with a first optical assembly 20 may be first mounted on a light adjustment device, and then a position of a second lens barrel 300 mounted with the second optical assembly 300 is adjusted through the light adjustment device, so that the second optical assembly 30 reaches a preset mounting position and then a second lens barrel 300 corresponding to the second optical assembly 30 reaching the preset mounting position through adjustment can be fixed on the bracket 10, thereby implementing light adjustment of the optical system 1. In a related art, because the first optical assembly 20 and the second optical assembly 30 are assembled through the lens barrel, when the optical system is light-adjusted, a position of the lens barrel mounted with the first optical assembly 20 and a position of the lens barrel mounted with the second optical assembly 300 need to be adjusted respectively, so that the first optical assembly 20 and the second optical assembly 30 are fixed on the bracket 10 after the first optical assembly 20 and the second optical assembly 30 reach their respective preset mounting positions respectively, resulting in a complex light adjustment process. The optical system provided in this embodiment can simplify the light adjustment process.

This embodiment also provides a LiDAR. A difference between the LiDAR and that in Embodiment 1 is as follows. An optical system 1 in the LiDAR also includes two second lens barrels 300 for assembling two second optical assemblies 30, and the two second lens barrels 300 are mounted in the two second accommodation cavities 14 respectively. A second light-transmitting channel 310 is provided in the second lens barrel 300, and the second light-transmitting channel 310 extends along the second axial direction AX2. Optical elements included in the two second optical assemblies 30 are arranged in second light-transmitting channels 310 of their respective second lens barrels 300 along the second axial direction AX2.

Embodiment 3 is as follows.

A difference between this embodiment and Embodiment 1 or 2 is as follows. A first optical assembly 20 is located on a light-emitting side of a light-emitting module 2 and is configured to: receive a laser beam emitted by the light-emitting module 2 and emit an outgoing laser beam to a detection region. A second optical assembly 30 is located on a light incident side of a detection module 3 and is configured to: receive an echo laser beam returned after the outgoing laser beam is reflected by an obstacle in the detection region, and focus the echo laser beam on the detection module 3.

What is claimed is:

1. An optical system, comprising:
a bracket, comprising a first end surface and a second end surface that are arranged back to back, wherein the bracket is also provided with a first accommodation cavity, and the first accommodation cavity extends along a first axial direction and communicates with the first end surface and the second end surface; and
at least one first optical assembly, wherein each of the at least one first optical assembly comprises at least one optical element, and the at least one optical element comprised in the first optical assembly is arranged in the first accommodation cavity along the first axial direction, and abuts against an inner wall of the first accommodation cavity.

2. The optical system according to claim 1, wherein the optical system further comprises a first restrictive assembly, and the first restrictive assembly is connected to the inner wall of the first accommodation cavity and is configured to restrict the optical element comprised in the first optical assembly.

3. The optical system according to claim 2, wherein the inner wall of the first accommodation cavity comprises a first inner wall portion, a first middle inner wall portion, and a second inner wall portion arranged sequentially along the first axial direction, the first optical assembly comprises one or more lenses, each of the one or more lenses has two optical surfaces arranged opposite each other along the first axial direction, the one or more lenses comprised in the first optical assembly abuts against the first middle inner wall portion, and the first restrictive assembly further comprises:
a first restrictive member, wherein the first restrictive member is connected to the first inner wall portion and abuts against a first optical surface; and
a second restrictive member, wherein the second restrictive member is connected to the second inner wall portion and abuts against a second optical surface, wherein the first optical surface is an optical surface at a first position when the lenses comprised in the first optical assembly are arranged along the first axial direction, and the second optical surface is an optical surface at a last position when the lenses comprised in the first optical assembly are arranged along the first axial direction.

4. The optical system according to claim 3, wherein the first optical assembly comprises multiple lenses;
wherein the first restrictive assembly further comprises a spacer; and
wherein one spacer is disposed between each two adjacent lenses in the multiple lenses comprised in the first optical assembly, and the spacer is configured to separate the two adjacent lenses.

5. The optical system according to claim 1, wherein the optical system further comprises a light-transmitting sheet, and the light-transmitting sheet is connected to the first end surface of the bracket and comprises a first light-transmitting surface facing toward the first end surface;
wherein and the light-transmitting sheet is configured to protect the first optical assembly and is also configured to allow light corresponding to the first optical assembly to pass through;
wherein a first through hole communicating with the first accommodation cavity is disposed on the first end surface;
wherein there is a first sealing path on the first end surface, and the first sealing path is disposed around the first through hole;
wherein the optical system further comprises a first sealed connection structure and a second sealed connection structure;
wherein the first sealed connection structure forms sealed connection between the first sealing path and the first light-transmitting surface, and the second sealed connection structure forms sealed connection between a first optical element and the inner wall of the first accommodation cavity; and
wherein the first optical element is an optical element at a first position when the optical elements comprised in the first optical assembly are arranged along the first axial direction.

6. The optical system according to claim 5, wherein:
the first sealed connection structure comprises a first sealing bulge, a first sealing groove, and a first sealing rubber ring; and
the first sealing bulge is disposed on the first end surface and along the first sealing path, and the first sealing groove is disposed on the first light-transmitting surface and corresponds to the first sealing bulge; or, the first sealing groove is disposed on the first end surface and along the first sealing path, and the first sealing bulge is disposed on the first light-transmitting surface and corresponds to the first sealing groove; and the first sealing rubber ring is filled in the first sealing groove, and the first sealing bulge is embedded in the first sealing groove to be seal-connected to the first sealing groove through the first sealing rubber ring; or
the first sealed connection structure comprises a first welded connection structure, and the first welded connection structure is a welded structure formed after the first end surface and the first light-transmitting surface are welded along the first sealing path.

7. The optical system according to claim 1, wherein the bracket is further provided with a second accommodation cavity, the second accommodation cavity extends along a second axial direction and communicates with the first end surface and the second end surface, the optical system further comprises a second optical assembly, and the second optical assembly comprises at least one optical element; and
wherein the at least one optical element comprised in the second optical assembly is arranged in the second accommodation cavity along the second axial direction and abuts against an inner wall of the second accommodation cavity; or the optical system further comprises a second lens barrel, the second lens barrel is provided with a second light-transmitting channel, the second light-transmitting channel extends along the second axial direction, the at least one optical element comprised in the second optical assembly is arranged in the second light-transmitting channel along the second axial direction, and the second lens barrel is mounted in the second accommodation cavity and connected to the inner wall of the second accommodation cavity.

8. The optical system according to claim 7, wherein the at least one optical element comprised in the second optical assembly is arranged in the second accommodation cavity along the second axial direction and abuts against the inner wall of the second accommodation cavity; and
wherein the optical system further comprises a second restrictive assembly, and the second restrictive assembly is connected to the inner wall of the second accommodation cavity and is configured to restrict the optical element comprised in the second optical assembly.

9. The optical system according to claim 8, wherein the inner wall of the second accommodation cavity comprises a third inner wall portion, a third middle inner wall portion, and a fourth inner wall portion arranged sequentially along the second axial direction, the second optical assembly comprises one or more lenses, each of the one or more lenses has two optical surfaces arranged opposite each other along the second axial direction, and the one or more lenses comprised in the second optical assembly abuts against a second middle inner wall portion, and the second restrictive assembly further comprises:
a third restrictive member, wherein the third restrictive member is connected to the third inner wall portion and abuts against a third optical surface; and
a fourth restrictive member, wherein the fourth restrictive member is connected to the fourth inner wall portion and abuts against a fourth optical surface,
wherein the third optical surface is an optical surface at a first position when the lenses comprised in the second optical assembly are arranged along the second axial direction, and the fourth optical surface is an optical surface at a last position when the one or more lenses comprised in the second optical assembly are arranged along the second axial direction.

10. The optical system according to claim 9, wherein the second optical assembly comprises multiple lenses;
wherein the second restrictive assembly further comprises a spacer; and
wherein the spacer is disposed between each two adjacent lenses in the multiple lenses comprised in the first optical assembly, and the spacer is configured to separate the two adjacent lenses.

11. The optical system according to claim 7, wherein:
the optical system further comprises a light-transmitting sheet, the light-transmitting sheet is connected to the first end surface of the bracket and comprises a first light-transmitting surface facing toward the first end surface, and the light-transmitting sheet is configured to protect the first optical assembly and the second optical assembly and is also configured to allow light corresponding to the first optical assembly and the second optical assembly to pass through;
a first through hole communicating with the first accommodation cavity is disposed on the first end surface, there is a first sealing path on the first end surface, the first sealing path is disposed around the first through hole, the optical system further comprises a first sealed connection structure and a second sealed connection structure, the first sealed connection structure forms sealed connection between the first sealing path and the first light-transmitting surface, and the second sealed connection structure forms sealed connection between the first optical element and the inner wall of the first accommodation cavity, and the first optical element is the optical element at the first position when the optical elements comprised in the first optical assembly are arranged along the first axial direction; or
a second through hole communicating with the second accommodation cavity is disposed on the first end surface, there is also a second sealing path on the first end surface, the second sealing path is disposed around the second through hole, the optical system also comprises a third sealed connection structure and a fourth sealed connection structure, the third sealed connection structure forms sealed connection between the second sealing path and the first light-transmitting surface, and the fourth sealed connection structure forms sealed connection between a second optical element and the inner wall of the second accommodation cavity, and the second optical element is an optical element at a first position when the optical elements comprised in the second optical assembly are arranged along the second axial direction.

12. The optical system according to claim 11, wherein the first end surface has the second sealing path, and the optical system comprises the third sealed connection structure and the fourth sealed connection structure;
wherein the third sealed connection structure comprises a third sealing bulge, a third sealing groove, and a third sealing rubber ring;
wherein the third sealing bulge is disposed on the first end surface and along the first sealing path, and the third sealing groove is disposed on the first light-transmitting surface and corresponds to the third sealing bulge; or the third sealing groove is disposed on the first end surface and along the first sealing path, and the third sealing bulge is disposed on the first light-transmitting surface and corresponds to the third sealing groove; and
wherein the first sealing rubber ring is filled in the third sealing groove, and the third sealing bulge is embedded in the first sealing groove to be seal-connected to the third sealing groove through the third sealing rubber ring; or the third sealed connection structure comprises a second welded connection structure; and the second welded connection structure is a welded structure formed after the first end surface and the first light-transmitting surface are welded along the second sealing path.

13. The optical system according to claim 11, wherein the first end surface has the first sealing path and the second sealing path;
wherein the optical system further comprises the first sealed connection structure and the third sealed connection structure;
wherein there is a shared sealing section between the first sealing path and the second sealing path; and
wherein the first sealed connection structure and the third sealed connection structure share a partial structure.

14. The optical system according to claim 11, wherein the first end surface has the first sealing path and the second sealing path;
wherein the first end surface further has at least one third sealing path, and the at least one third sealing path is disposed around the first sealing path and the second sealing path; and
wherein the optical system also comprises a fifth sealed connection structure, and the fifth sealed connection structure forms a sealed connection between the third sealing path and the first light-transmitting surface.

15. The optical system according to claim 14, wherein the fifth sealed connection structure comprises a fifth sealing bulge, a fifth sealing groove and, a fifth sealing rubber ring;
wherein the fifth sealing bulge is disposed on the first end surface and along the third sealing path, and the fifth sealing groove is disposed on the first light-transmitting surface and corresponds to the fifth sealing bulge; or the fifth sealing groove is disposed on the first end surface and along the third sealing path, and the fifth sealing bulge is disposed on the first light-transmitting surface and corresponds to the fifth sealing groove; and the fifth sealing rubber ring is filled in the fifth sealing groove; and
wherein the fifth sealing bulge is embedded in the fifth sealing groove to be seal-connected to the fifth sealing groove through the fifth sealing rubber ring; or the fifth sealed connection structure comprises a third welded connection structure, and the third welded connection structure is a welded structure formed after the first end surface and the first light-transmitting surface are welded along the third sealing path.

16. The optical system according to claim 1, wherein the light-transmitting sheet is attached to the first end surface.

17. A LiDAR, comprising the optical system according to claim 7, wherein the LiDAR further comprises a housing, a light-emitting module, and a detection module, wherein:
the housing is connected to the second end surface, and after the housing is connected to the second end surface, an accommodation cavity is formed;
the light-emitting module and the detection module are both disposed in the accommodation cavity; and
the second optical assembly is located on a light-emitting side of the light-emitting module and is configured to receive a laser beam emitted by the light-emitting module and to emit an outgoing laser beam to a detection region, and the first optical assembly is located on a light incident side of the detection module and is configured to receive an echo laser beam returned after the outgoing laser beam is reflected by an obstacle in the detection region and to focus the echo laser beam on the detection module; or
the first optical assembly is located on the light-emitting side of the light-emitting module and is configured to receive the laser beam emitted by the light-emitting module and to emit the outgoing laser beam to the detection region, and the second optical assembly is located on the light incident side of the detection module and is configured to receive the echo laser beam returned after the outgoing laser beam is reflected by the obstacle in the detection region and focus the echo laser beam on the detection module.

18. The LiDAR according to claim 17, wherein the LiDAR comprises two light-emitting modules and one detection module, and the two light-emitting modules are located on two sides of the detection module;
wherein the optical system comprises two second optical assemblies and one first optical assembly, the two second optical assemblies are located on two sides of the first optical assembly and are respectively located on light-emitting sides of the two light-emitting modules, and the first optical assembly is located on the light incident side of the detection module; and
wherein the light-emitting module is disposed along a horizontal direction on one side in the second axial direction that is farther away from the first optical assembly, and the light-emitting modules are symmetrically disposed along a vertical direction on two sides in the first axial direction.

19. The LiDAR according to claim 18, wherein a first through hole communicating with the first accommodation cavity is further disposed on the first end surface;
wherein the inner wall of the first accommodation cavity further comprises a first light blocking inner wall, and the first light blocking inner wall is located at the first through hole and one end of the first optical assembly that is closer to the first through hole;
wherein space defined by the first light blocking inner wall is configured to allow light within a preset receiving optical path range to enter the first optical assembly; and
wherein a first light blocking groove is disposed on at least part of a wall surface of the first light blocking inner wall.

20. The LiDAR according to claim 18, wherein a second through hole communicating with the first accommodation cavity is further disposed on the first end surface;
wherein the inner wall of the second accommodation cavity also comprises a second light blocking inner wall, and the second light blocking inner wall is located at the second through hole and one end of the second optical assembly that is closer to the second through hole;
wherein space defined by the second light blocking inner wall is configured to allow light emitted by the second optical assembly to be emitted outward within a preset emission optical path range; and
wherein a second light blocking groove is disposed on at least part of a wall surface of the second light blocking inner wall.
